(19) United States
(12) Patent Application Publication
(10) Pub. No.: US 2020/0118137 A1
(43) Pub. Date: Apr. 16, 2020

(54) TRANSACTION MANAGEMENT SYSTEM

(71) Applicant: PRIV8PAY, INC., Saratoga, CA (US)

(72) Inventors: Vishal Sood, Santa Clara, CA (US); Ioannis Georgiadis, Voula (GR); Gopalakrishnan Hariharan, Highlands Ranch, CO (US); John K. Thomas, Saratoga, CA (US)

(21) Appl. No.: 16/653,657

(22) Filed: Oct. 15, 2019

Related U.S. Application Data
(60) Provisional application No. 62/745,865, filed on Oct. 15, 2018.
(60) Provisional application No. 62/821,701, filed on Mar. 21, 2019.
(60) Provisional application No. 62/823,462, filed on Mar. 25, 2019.
(60) Provisional application No. 62/890,426, filed on Aug. 22, 2019.

(51) Int. Cl. G06Q 20/40; G06Q 40/00; G06N 20/00; G06F 3/0481

(52) U.S. Cl. CPC G06Q 20/4016; G06F 3/04817; G06N 20/00; G06Q 40/12

(57) ABSTRACT

A transaction management service and method are disclosed that can streamline transaction tracking and budget management. Transactions may be pre-approved based on inheritance and/or context-based authorization. The system can integrate a payment method, transaction tracking service, and a budget allocation service, among other operations.

### CROSS-CITATION TO RELATED APPLICATIONS

The present application claims the benefits of and priority, under 35 U.S.C. § 119(e), to U.S. Provisional Application Ser. No. 62/745,865, filed on Oct. 15, 2018, entitled “EXPENSE AND BUDGET MANAGEMENT SERVICE”; 62/821,701 filed Mar. 21, 2019, entitled “EXPENSE AND BUDGET MANAGEMENT SERVICE”; 62/823,462 filed Mar. 25, 2019, entitled “EXPENSE AND BUDGET MANAGEMENT SERVICE”; and 62/890,426 filed Aug. 22, 2019 entitled “EXPENSE AND BUDGET MANAGEMENT SERVICE.” The entire disclosure of the applications listed above are hereby incorporated by reference, in their entirety, for all that they teach and for all purposes.

### COPYRIGHT NOTICE

A portion of the disclosure of this patent document contains material that is subject to copyright protection. The copyright owner has not objected to the facsimile reproduction by anyone of the patent document or the patent disclosure as it appears in the Patent and Trademark Office patent files or records, but otherwise reserves all copyright rights whatsoever.

### FIELD OF THE DISCLOSURE

The disclosure relates generally to a transaction management system and service for tracking and authorizing transactions integrated with a budget management system and service for managing and allocating budgets.

### BACKGROUND

Buyers exchange money for goods and/or services provided by vendor/sellers. Transactions may be conducted in person, over the phone, or even over the Internet. The money exchanged may be in the form of cash, check, or electronic transactions such as credit card purchases. In the case of electronic transactions, the buyer must provide the vendor with credentials, such as a credit card number.

In addition, some users may load their credit card and/or banking information into an app on their smart devices, such as phone or watch, in order to pay for transactions.

One example of this type of payment is APPLE PAY®, which allows a user to pay for purchases using their IPHONE® or APPLE WATCH® and also make in app purchases. This method of payment still utilizes the traditional model of a buyer providing credentials, a vendor requesting payment from the bank or issuer of the card, and the financial institution approving/denying the transaction. Transaction may be denied for various reasons, such as insufficient funds, expired credentials, etc.

Traditional transaction tracking requires manual entry on each transaction. In some cases, employees enter the transactions into a spreadsheet or a similar format and submit the itemized list along with supporting documentation such as receipts to an individual responsible for reviewing and approving the transactions. Once the transactions are approved, the employee is issued a check for the approved amount. Technology has introduced improvements, such as direct deposits instead of physical checks. Other improvements include transaction tracking apps that link to a user's bank and/or other accounts to aggregate transaction data. However, these apps require the user to enter sensitive data, such as bank account information into the app, which increases the potential for identity theft. Furthermore, these apps do not provide protection against fraudulent transactions nor do they alleviate the cumbersome approval process associated with traditional transaction tracking and authorization. In some cases, the fraudulent activity may be unintentional or “friendly,” such as an employee accidently using a corporate credit card for a personal transaction. In other cases, the fraud may be more malicious.

The current methods available for transaction tracking cannot detect fraudulent activity. For example, an employee may submit an expense report that includes transactions that were not actually purchased. In some cases, the employee may have the appropriate supporting documentation. For instance, the employee may procure a receipt for a transaction that was never made. In another example, the employee may request a receipt for a higher amount than the actual purchase price. Some vendors may provide a blank receipt that allows the submitter to enter any amount he chooses. There are also websites where individuals can purchase a forged receipt that is made to look like a receipt from a legitimate vendor. In addition to fraudulent activity on the part of the submitter, the fraudulent activity may be perpetrated by other individuals, such as in the case of identity theft or a vendor inadvertently or intentionally making additional charges. From an employee's perspective traditional expense tracking can be cumbersome due to the supporting documentation required to be submitted in conjunction with the itemized ledger of transactions. For example, if the employee loses or otherwise misplaces a receipt, the associated transaction may be denied, causing the employee to have to absorb the cost. In some situations, the employee may not receive a receipt at all, or the receipt may not be detailed enough.

In addition to the problems with fraud and documentation, the traditional method of expense tracking and reimbursement requires a cumbersome and time-consuming process of approval. An individual is required to review and approve each transaction. Part of this review includes ensuring that the proper documentation is submitted. When the proper documentation is not submitted, the approver must spend additional time requesting the required documentation, which further delays the process. Employee users and approver users would benefit from a more streamlined, automated, integrated system for tracking, managing, and approving transactions.

Users may be able to download and install expense tracking apps on their devices, such as phones, wearable devices, tablets, and laptops. Many apps, including expense tracking apps, send notifications to the user. These notifications indicate that there is information for the user. For example, an email app may notify the user of new or unread messages. A calendar app may notify the user of an upcoming event. A settings app may notify the user that a software update is available. A phone app may notify the user of missed calls and voicemails. These notifications may be turned on/off by the user.

One method of displaying or indicating the presence of these notifications is when the user is in the home screen or a screen that displays the application launch icons for the various apps on the device, there may be a number in white on a red circle in the upper right-hand corner of the app. These badges indicate to the user that there are one or more notifications waiting. In the case of the email app, the badge may indicate the number of unread messages. In the calendar app example, the badge may indicate the number of upcoming events, reminders, alarms, etc. The number displayed in the badge may count down as the user views the notifications, and once the user views all the notifications the badge may disappear. Considering the calendar app example, after the user opens the calendar app and views the upcoming events, the badge may disappear.

Currently, badge notifications only display the total notifications received in any channel for the app. A badge associated with the phone app may indicate the total number of missed calls and voicemails the user has received. However, since the badge notifications is for any and all channels, if the phone app badge displays a “3,” the user would not know how many of the three notifications are missed calls and/or how many of the three notifications comprise voicemails. For instance, the user may have three missed calls and no voicemails. However, the user may also have two missed calls and one voicemail message. In another example, the badge for a mail app may indicate the number of unread emails, but the user may desire to know the number of new messages received since the last time their inbox was updated in addition to the number of unread emails.

In additional to expense tracking, many companies and individuals deal with budgeting. For example, a company may have a given budget for providing employees with work devices, such as phones and computers, and other items. Another budget for travel and associated expenses, such as hotel accommodations. Another budget for marketing, including taking clients out for dinner. The budget may be broken down by type and/or individual/department. Generally, someone, such as a manager, in the department will be given the duty of managing and allocating the budget. In some cases, the budget may be split between the individuals in the department. The individuals may be apportioned a part of the budget based on their position or title. For example, in a law firm, a partner may be given a larger portion of the travel budget than an associate. However, in some cases, the manager may desire to re-allocate the budget. For instance, near the end of the fiscal year, if there remains a balance in the travel allocation for the partner, the manager may select to re-allocate this remaining amount to another employee. Currently, there is no app/software that integrates transaction tracking/authorization and budget management.

Compound information is information that is combined from multiple sources, each of which has its own set of requirements and rules for releasing information. Rapid formulation of queries for compound information is also challenging in real-time or near real-time scenarios. Retrieval of compound information (from multiple, centrally owned and operated systems) is operationally difficult and subject to manipulation and fraud. Each entity that owns and controls information establishes its own rules and protocols for accessing the information it controls. As a result, a third-party who wishes to find or validate a piece of data has to find the system that controls that data, communicate to that system using the correct protocols and then rely on the system being available to access the information.

### SUMMARY

These and other needs are addressed by the various aspects, embodiments, and/or configurations of the present disclosure.

In certain embodiments, the present disclosure relates to a transaction management system that can include a communications interface that enables communications with a communication device of a selected user, an arithmetic logic unit (“ALU”) and/or control unit “(CU”) coupled to the communications interface to perform one or more mathematical operations and compare selected variables, a register to hold a value from a comparison of selected variables performed by the ALU and/or CU; an instruction decoder to provide read and write commands to memory; an address bus to provide a location address to memory for a read or write operation; a data bus to provide or access data for a write or read operation to or from memory and a computer-readable storage memory coupled with the ALU and/or CU, register, instruction decoder, address bus, and data bus. The memory can include instructions that are executable by the ALU and/or CU, and the instructions in turn can include: receiving transaction data for approval, wherein the transaction data includes attribute data; deriving the context information for the transaction data from at least one of a financial institution associated with the transaction data, a vendor associated with the transaction data, a user associated with the transaction data, and/or an employer associated with the user; determining whether to approve the transaction data based on at least one of the attribute data and the derived context information; and in response to the transaction data being pre-approved, updating a record associated with the transaction data to indicate the approval. As used herein, an arithmetic logic unit refers to an arithmetic unit, logic unit, or a unit in combining both.

In certain embodiments, the present disclosure relates to a transaction management system that can include a communications interface that enables communications with a communication device of a selected user, an ALU and/or CU coupled to the communications interface to perform one or more mathematical operations and compare selected variables, a register to hold a value from a comparison of selected variables performed by the ALU and/or CU; an instruction decoder to provide read and write commands to memory; an address bus to provide a location address to memory for a read or write operation; a data bus to provide or access data for a write or read operation to or from memory and a computer-readable storage memory coupled with the ALU and/or CU, register, instruction decoder, address bus, and data bus. The memory can include instructions that are executable by the ALU and/or CU, and the instructions in turn can include: receiving by the ALU and/or CU and from a computing device, a transaction for approval; updating transaction data associated with the transaction to indicate that the transaction has a first state; processing, by the ALU and/or CU, a set of authorization rules; determining, by the ALU and/or CU, whether to pre-approve the transaction based on the set of authorization rules; in response to the transaction not being pre-approved, submitting, by the ALU and/or CU, the transaction for approval; in response to the transaction being pre-approved, not submitting, by the ALU and/or CU, the transaction for approval; and thereafter updating transaction data to change a state of the transaction from the first state to a different second state.

In certain embodiments, the present disclosure relates to a transaction management system that can include a communications interface that enables communications with a communication device of a selected user, an ALU and/or CU coupled to the communications interface to perform one or more mathematical operations and compare selected variables, a register to hold a value from a comparison of selected variables performed by the ALU and/or CU; an instruction decoder to provide read and write commands to memory; an address bus to provide a location address to memory for a read or write operation; a data bus to provide or access data for a write or read operation to or from memory, and a computer-readable storage memory coupled with the ALU and/or CU, register, instruction decoder, address bus, and data bus. The memory can include instructions that are executable by the ALU and/or CU, and the instructions in turn can include: maintaining multiple counters associated with multiple notifications from multiple channels within the application and displaying an application launch icon associated with the application, wherein the application launch icon is able to simultaneously display multiple badges associated with the multiple notifications.

In certain embodiments, the present disclosure relates to a transaction management system that can include a communications interface that enables communications with a communication device of a selected user, an ALU and/or CU coupled to the communications interface to perform one or more mathematical operations and compare selected variables, a register to hold a value from a comparison of selected variables performed by the ALU and/or CU; an instruction decoder to provide read and write commands to memory; an address bus to provide a location address to memory for a read or write operation; a data bus to provide or access data for a write or read operation to or from memory, and a computer-readable storage memory coupled with the ALU and/or CU, register, instruction decoder, address bus, and data bus. The memory can include instructions that are executable by the ALU and/or CU, and the instructions in turn can include: receiving a balance inquiry associated with a transaction, wherein the balance inquiry is associated with a first company in a plurality of companies, wherein plural parallel processing threads are currently processing different balance inquiries for the different companies, and wherein each of the processing threads corresponds to a different one of the plurality of companies; comparing selected information in the received balance inquiry with plural sets of information associated with the plurality of companies to determine that the balance inquiry is associated with the first company; processing the received balance inquiry in a first processing thread of the plurality of parallel processing threads associated with the first company; and updating transaction data associated with the transaction to reflect an output of the first processing thread.

The balance inquiry can be associated with a first employee of the first company in a plurality of employees of the first company.

Plural parallel processing threads can be currently processing a different balance inquiry associated with the first company and each of the processing threads can correspond to a different one of the plurality of employees.

The ALU and/or CU can further process, by the plurality of employee processing threads, the received balance inquiry to determine that the received balance inquiry corresponds to the first employee.

In each of the plural processing threads for the plurality of companies, a hash of a private account number associated with each of the plurality of companies can be compared against the selected information in the received balance inquiry and, in each of the plural processing threads for the plurality of employees, a hash of a communication address associated with each of the plurality of first company employees can be compared against the selected information in the received balance inquiry. As will be appreciated, a hash, also known as one-way encryption, is a mathematical function that condenses data to a fixed size, which is known as a hash value. Hashes can enable the ALU and/or CU, register, instruction decoder, address bus, and data bus to identify, compare, or otherwise run calculations against files and strings of data. The hashing algorithm can enable the ALU and/or CU to first compute the hash and then compare the hash values much more quickly and efficiently than it would be for the ALU and/or CU to compare directly the original files. Hashing algorithms further enable determinism. The hash values can enable any computer executing the corresponding hashing algorithm to locally compute the hash value repeatedly and predictably.

The ALU and/or CU can further compare a transaction category associated with a budget for the first employee against a transaction category associated with the received balance inquiry to determine whether to approve the received balance inquiry for payment; compare a date range associated with the budget life with a timestamp of the transaction to determine whether the budget is active to authorize payment of the received balance inquiry; and compare an amount of the budget with an amount of the transaction to determine whether the budget has adequate funds to authorize payment of the received balance inquiry.

In certain embodiments, the present disclosure relates to a transaction management system that can include a communications interface that enables communications with a communication device of a selected user, an ALU and/or CU coupled to the communications interface to perform one or more mathematical operations and compare selected variables, a register to hold a value from a comparison of selected variables performed by the ALU and/or CU; an instruction decoder to provide read and write commands to memory; an address bus to provide a location address to memory for a read or write operation; a data bus to provide or access data for a write or read operation to or from memory, and a computer-readable storage memory coupled with the ALU and/or CU, register, instruction decoder, address bus, and data bus. The memory can include instructions that are executable by the ALU and/or CU, and the instructions in turn can include: receiving transaction data relating to a selected transaction and a budget for the selected transaction, the selected transaction and budget being associated with an identified first user; applying, by a rules engine, a set of deterministic rules to the transaction data to provide a first outcome for the selected transaction; applying, by the rules engine, a set of heuristic rules to the transaction data to provide a second outcome for the selected transaction; processing, by a machine learning module and using learnings, the first and second outcomes to provide a third outcome of the transaction; receiving input from a human reviewer to convert the first, second, and third outcomes into a final outcome; and updating the learnings to comprise the final outcome to be applied by the machine learning module to a future transaction.

In some embodiments, a method of providing transaction management comprises: receiving transaction data for approval, wherein the transaction data includes attribute data; deriving context information for the transaction data from at least one of a financial institution associated with the transaction data, a vendor associated with the transaction data, a user associated with the transaction data, and/or an employer associated with the user; determining whether to approve the transaction data based on at least one of the attribute data and the derived context information; and in response to the transaction data being pre-approved, updating a record associated with the transaction data to indicate the approval.

In some embodiments, a method for providing discrete and separate notifications for an application running on a communication device comprises: maintaining multiple counters associated with multiple notifications from multiple channels within the application; and displaying an application launch icon associated with the application, wherein the application launch icon is able to simultaneously display multiple badges associated with the multiple notifications.

In some embodiments, a method comprises: receiving by a microprocessor and from a computing device, a transaction for approval; processing, by the microprocessor, a set of authorization rules; determining, by the microprocessor, whether to pre-approve the transaction based on the set of authorization rules; in response to the transaction not being pre-approved, submitting, by the microprocessor, the transaction for approval; and in response to the transaction being pre-approved, not submitting, by the microprocessor, the transaction for approval.

In some embodiments, a method comprises: receiving a balance inquiry associated with a transaction, wherein the balance inquiry is associated with a first company in a plurality of companies, wherein plural parallel processing threads are currently processing different balance inquiries for the different companies, and wherein each of the processing threads corresponds to a different one of the plurality of companies; comparing selected information in the received balance inquiry with plural sets of information associated with the plurality of companies to determine that the balance inquiry is associated with the first company; processing the received balance inquiry in a first processing thread of the plurality of parallel processing threads associated with the first company; and updating transaction data associated with the transaction to reflect an output of the first processing thread.

In some embodiments, a method comprises: receiving transaction data relating to a selected transaction and a budget for the selected transaction, the selected transaction and budget being associated with an identified first user; applying, by a rules engine, a set of deterministic rules to the transaction data to provide a first outcome for the selected transaction; applying, by the rules engine, a set of heuristic rules to the transaction data to provide a second outcome for the selected transaction; processing, by a machine learning module and using learnings, the first and second outcomes to provide a third outcome of the transaction; receiving input from a human reviewer to convert the first, second, and third outcomes into a final outcome; and updating the learnings to comprise the final outcome to be applied by the machine learning module to a future transaction.

The various embodiments discussed in the disclosure can provide advantages. For example, it can enable secure and efficient transaction tracking and budget management between companies (e.g., employers), employees, vendors, and financial institutions. Certain transactions may inherit content and/or approval from other related transactions. Transactions could refer to individual transactions and/or a group of related transactions.

In addition to transactions, the method and systems described herein may be used to process invoices in a similar manner. For example, approval of an invoice/purchase order may transfer to approval of the transaction related to that invoice. Additionally, invoices may be linked to one or more transactions. Invoices may also include adjustments and partial payments.

The present disclosure can provide a number of advantages depending on the particular aspect, embodiment, and/or configuration. These and other advantages will be apparent from the disclosure.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any computer-readable storage and/or transmission medium that participate in providing instructions to a processor for execution. Such a computer-readable medium can be tangible, non-transitory, and non-transient and take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

A “computer readable storage medium” may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A “computer readable signal medium” may be any computer readable medium that is not a computer readable storage medium and that can communicate, propagate, or transport a program for use by or in connection with an instruction execution system, apparatus, or device. A computer readable signal medium may convey a propagated data signal with computer readable program code embodied therein, for example, in baseband or as part of a carrier wave. Such a propagated signal may take any of a variety of forms, including, but not limited to, electro-magnetic, optical, or any suitable combination thereof. Program code embodied on a computer readable signal medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section(s) 112(f) and/or 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “module” as used herein refers to any known or later developed hardware, software, firmware, artificial intelligence, fuzzy logic, or combination of hardware and software that is capable of performing the functionality associated with that element.

The terms ‘service” and “system” as used interchangeably herein and may refer to the hardware used to provide the service, the service, or both. The terms may also refer the application installed on the user device. The description herein describes a system for providing a service.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

The present disclosure is described in conjunction with the appended figures:

FIG. 1 is a block diagram of a transaction management system in an embodiment of a system according to the present disclosure;

FIG. 2A is a block diagram of a transaction monitor according to the present disclosure;

FIG. 2B is a block diagram of a user device operable to execute as the one or more devices described herein, including any of the applications, architectures, elements, processes, and operational scenarios and sequences illustrated in the Figures and discussed below in the Detailed Description;

FIG. 3A is a block diagram of a transaction data structure for attribute data according to the present disclosure;

FIG. 3B is a block diagram of a transaction data structure for context data according to the present disclosure;

FIG. 4 is a block diagram of a budget data structure according to the present disclosure;

FIG. 5 is a flow diagram illustrating a method for transaction approval according to the present disclosure;

FIG. 6 is a block diagram of an embodiment of a transaction container including transactions and event data according to the present disclosure;

FIG. 7 is a data structure showing matrix settlement according to the present disclosure;

FIG. 8A is a flow diagram of an embodiment of a sorting and deciding process according to the present disclosure;

FIG. 8B is a block diagram of a data structure used in the sorting and deciding process according to the present disclosure;

FIG. 9 is a flow diagram for an invoice workflow according to the present disclosure;

FIG. 10A is a flow diagram of a transaction workflow according to the present disclosure;

FIG. 10B is an example screenshot of an employee view of expense items awaiting submission according to the present disclosure;

FIG. 10C is a block diagram of an optional merchant rating tool according to the present disclosure;

FIG. 10D is an example screenshot of an employee view for generating a transaction, including adding receipt data, according to the present disclosure;

FIG. 10E is an example screenshot of an employee view for itemizing and allocating an expense item according to the present disclosure;

FIG. 10F is another example screenshot of an employee view for allocating an expense item according to the present disclosure;

FIG. 10G is an example screenshot of an employee view for a chat session according to the present disclosure;

FIG. 10H is an example screenshot of a manager view of transactions(s) awaiting approval according to the present disclosure;

FIG. 10I is an example screenshot of an employee view for manually generating an expense item according to the present disclosure;

FIG. 10J is another example screenshot of an employee view for manually generating a mileage expense item according to the present disclosure;

FIG. 10K is another example screenshot of an employee view for manually generating a time expense item according to the present disclosure;

FIG. 10L is an example screenshot of an employee view of the available budget(s) per credit instrument and requesting additional funds according to the present disclosure;

FIG. 10M is another example screenshot of a view for budget data according to the present disclosure;

FIG. 11 depicts adjustments to a transaction according to the present disclosure;

FIG. 12 depicts a block diagram of state transitions for a transaction according to the present disclosure;

FIG. 13A illustrates a context engine according to the present disclosure;

FIG. 13B is a block diagram of a transaction data structure for learnings according to the present disclosure;

FIG. 13C is a flow illustrating a workflow for the context engine according to the present disclosure;

FIG. 14 is a block diagram that depicts a transaction management application according to the present disclosure;

FIG. 15 is a block diagram of the transaction application with multiple notifications according to the present disclosure;

FIG. 16 is a screenshot of the transaction management application user interface according to the present disclosure;

FIG. 17 is a screenshot of the transaction management application user interface according to the present disclosure;

FIG. 18 is a screenshot of the transaction management application user interface with multiple notifications according to the present disclosure;

FIG. 19 depicts an expanded view of the multiple notification according to the present disclosure;

FIG. 20 is a block diagram of hardware for the transaction monitor according to the present disclosure; and

FIG. 21 is a block diagram of hardware for the transaction monitor according to the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

Prior to discussing the components and detailed operations of the transaction management system, a simplified illustration of the system is provided. A transaction management system according to some embodiments of this disclosure is a system that incorporates information from multiple sources such as, but not limited to, vendors, users, companies, and financial institutions. A user may interact with the transaction management system via their personal devices using a transaction management application. The transaction management application may provide multiple notifications associated with multiple channels. The notifications may be indicated using various icons, such that the user may differentiate the notifications from the different channels (e.g., the voicemails notifications separately indicated from the missed call notifications). The foregoing options can be used alone or collectively depending on the application.

Prior to discussing the components and detailed operations of the transaction management system, a simplified illustration of the system is provided.

In some embodiments, the transaction management system, through transactions over a distributed processing network such as the Internet, tracks and authorizes transactions. The transaction management system can also allow users to manually enter transactions. The transaction management system can provide a unified solution that integrates multiple systems to reduce human interaction/input and reduce corporate liability and fraud. For example, the transaction management system can integrate systems associated with users, employers, vendors, and financial institutions.

The transaction management methods and systems disclosed herein can use attributes, context, and inheritance to group, pre-authorize, approve, and/or estimate transactions, thereby simplifying transaction tracking and authorization and budget management. For example, transactions may be deducted from the proper budget in real-time, so that the available budget is accurate at all times. In traditional budgeting systems, a user may view the available budget and assume that there is a certain budget amount available, however, that user may not have knowledge that there are one or more pending transaction that will be deducted from the budget, thereby reducing the actual amount available. The transaction management service may be used in conjunction (i.e., both transaction and budget tracking and management) or separately (i.e., only transaction tracking and management or only budget tracking and management).

In some embodiments, a transaction may initiate with a proof of payment (e.g., authorization). In the next stage, a proof of purchase (e.g., a receipt) is received by the transaction monitor. For example, for a credit card transaction, the initial credit card authorization is the proof of payment. The legitimacy of the transaction comes from the receipt—proof of purchase. The payment and receipt need to be tied together (e.g., reconciliation). This can be done in myriad ways. The receipt data can be received through an image (e.g., optical character recognition (OCR)) or receipt data can be received in some text format. Settlement data is compared to transactions. Next, the legitimacy in a business context can be determined (e.g., this is a legitimate business expense). For example, while the employee is traveling for business, there is a transaction for NORDSTROMS®, using context information, the system may determine this is a non-business transaction, which could be an attribute (e.g., business or non-business) for the transaction. In another example, when a hotel transaction is itemized, it may include an item for an in-room movie, which may be considered a non-business transaction. The system may notify a manager that the employee should be responsible for this item of the hotel transaction.

The transaction management service can uniquely apply inheritance and context-based rules to pre-approve transactions. Advantageously, automatically approving transactions can reduce the processing burden on the system and on the human approver. For example, for pre-approved transactions, receipt data may not be required. In addition, real-time authorization allows increased fraud protection. A user (e.g., employee or employer) may be alerted of an anomalous transaction and able to immediately decline the transaction.

In some embodiments, the transaction management service can include a credit card issued and managed by the transaction management service to ensure seamless transactions. In some examples, the credit card may be turned on/off by the system. For instance, if the employee is traveling for work, the credit card may be activated when the employee starts the work trip and deactivated upon the end of the work trip (e.g., within a predetermined time period of the return flight home). In other examples, the credit card may be approved for certain vendors and/or purchase orders, such that the credit card will only allow approved transactions to go through. For instance, if the customer has a purchase order with a vendor, the credit card is approved for a specified amount (or up to a limit) for the particular vendor. The card will be declined for non-approved transactions. Pre-approval for purchase orders may be as specific as an itemized purchase order or more general such as approved for a specified amount or maximum amount.

In traditional transaction tracking, a user has to manually enter each transaction in an itemized list or ledger. In some cases, users create the itemized list or ledger using software for creating spreadsheets or the like. In addition to manually entering each transaction, employees must submit documentation such as receipts for each transaction. Often times, the supporting documentation needs to be scanned or otherwise digitally captured for submission, which further complicates the process. After the transactions are submitted, another user, such as a manager or approver needs to review each transaction and either approve or deny it. The approval process is time consuming, especially for routine and/or small transactions. In some instances, when the transaction is denied, additional documentation or explanation may be requested. This process may cause employees to miss reimbursements due to lost or inadequate documentation. In addition, an employee may take advantage of the current system and submit fraudulent transactions, such as submitting a receipt but not actually making a purchase. The transaction management system may be able to automate the entire transaction tracking workflow, with human approval required in the final stage. In some examples, certain activity may trigger alerts that require human input to resolve. Additionally, the transaction management system may apply machine learning to use gathered human approval data to improve the system's approval mechanisms.

In some embodiments, the transaction management service includes a software application (“app”) component that can be installed on a smart device, such as a smart phone, wearable device, tablet, or laptop. The app may have separate operations and views based on whether the user is a submitter (e.g., employee) or approver (e.g., manager). In one example, an employee/submitter user installs the app associated with the transaction management service on her smart phone device. In addition, the employee user may use a credit card issued by the entity providing the transaction management service, such as PRIV8PAY®. In some embodiments, the credit card may be issued by the same company that manages the transaction management service, however, the transaction management service may integrate with any financial institution or issuer of payment instruments. For example, the transaction management system may integrate with credit cards issued by a bank, such as CHASE®, CITI®, or WELLS FARGO®.

The employee user may use the issued credit card to purchase tickets for a business conference. The purchase may be submitted for approval to the approver user. The approver user approves the purchase transaction for the conference. The conference may be in another state, requiring the employee user to also purchase a plane ticket and hotel accommodations. The plane ticket and hotel reservation transactions may inherit approval from the conference ticket purchase, and therefore may be pre-approved and may be approved automatically without needing to be separately submitted to the approver. This streamlines the approval process by allowing certain transactions to inherit approval based on attributes and/or context data. Additionally, for pre-approved transactions, documentation such as receipts may not be required.

In some embodiments, the transaction management system utilizes price data (historical or current), preferences data, past behavior data, etc. to estimate the cost for the flight and hotel and provisionally encumber the budget based on the estimated cost. Therefore, the budget encumbrance may occur before the transaction. The transaction management system may list provisionally encumbrances separately from other transactions; and indicate a present budget amount available and a budget amount with the provisional transactions deducted.

In one example, context data may comprise a time window. Considering the example of the conference above, transactions within a given time window of the conference may be pre-approved. For instance, on the day of the conference there is a transaction for a taxi ride to the location of the conference, here there are multiple instances of context data, the time of the transaction in relation to the start time of the conference and the drop off location in relation to the location of the conference. Additionally, the approver user may preset an amount allowed for pre-approval. In other words, within a given time window all transactions less than the preset amount will be pre-approved and transactions that are more than the preset amount may require additional processing. In addition, or in the alternative, the preset amount may be for a cumulative amount per day or per trip. Therefore, any transaction within the time window will be pre-approved until the employee reaches the preset amount for the day and/or trip.

Moreover, context data for a transaction could include an estimated encumbrance on a budget, so if the employee requests approval for a trip, the system can determine that the trip will include expenses for airfare, hotel, per diem allowance, etc., The system may consider past behavior data, historical data, time of year, time to travel date, etc.; for example, this trip is similar to another trip that has taken place, therefore the system can determine an estimated cost for the trip, and using budget data, the system can further determine whether the trip should be approved. A user's past behavior data may include records of past transactions. Historical data may be organizational (e.g., other employees within an organization), industry specific (e.g., across companies within the same industry), and/or across organizations/industry (e.g., aggregated data). The system may also consider preferences, patterns, or settings configurable by each user and/or company.

In some embodiments, the transaction management service sends notifications to the users. For example, a user may be notified through the app when a transaction is approved/denied. Prior to denying a transaction, the user may receive a notification that additional documentation is requested. Each of these notifications may be indicated using a separate badge/notification. That is to say, the application launch icon associated with the transaction management application may separately indicate each notification. The user may submit the additional documentation directly within the app. For example, the app may have a built-in feature that allows the user to snap a picture of the requested documentation using his or her smart device and upload the picture using the app. This streamlines the process of gathering and submitting required documentation associated with the transactions. Furthermore, the app may display separate notifications for each channel. For example, notifications for messages related to approval/denial may have one associated badge notification and notifications for requests for additional information may have a separate associated badge notification.

In some embodiments, the app associated with the transaction management service installed on users' devices includes multiple counters for the multiple notifications. In other words, the transaction management app on the users' devices may include notification from multiple channels. For example, there may be notifications related to the transaction management module and other notifications associated with the budget management module. The app launcher icon for the app may be able to display multiple notifications (e.g., multiple badges). For example, the icon may have separate notification indicators for pending transactions and transactions that require additional information from the user. In other examples, the app may have multiple widgets that each have their own separate notification. For example, the transaction management system may have a widget for pending transactions and another widget for reminders. Each widget may have its own counter to track notifications for the user. The user may open the application and view each widget with its associated badge in a menu.

In some embodiments, the transaction management service provides real-time transaction tracking and approval. Therefore, an employee or approver user will immediately be notified of any attempted transactions and will be able to deny/reject transactions in real-time, providing additional fraud protection.

In some embodiments, the transaction management service provides a mechanism for users to rate merchants. The rating data may be aggregated to provide suggestions to other users. In some examples, a company may be provided with data based on the ratings. For example, a company may have employees that frequently travel to a customer site. The various employees book various accommodations, the rating data indicates that one hotel is rated higher than the others. The company may be notified of this and may use this information to suggest their employee book with this hotel. Additionally, the company may use this information to negotiate a discounted rate with the hotel as a preferred customer.

In addition to providing suggestions based on ratings, the transaction management service, in some embodiments, provides suggestions based on other factors such as cost. The transaction management service may track an employee user's usage of a per diem allowance and make suggestions based on the amount of per diem allowance remaining. For example, the service may recommend restaurants according to the average price of a meal based on the per diem balance remaining. The service may also consider expected expenses, such as transportation, in determining the remaining amount. For example, based on the user's location, the service determines that the user needs to take a taxi back to his hotel, the service can determine an estimated fare for the taxi ride, deduct that amount from the remaining per diem balance, even though the taxi ride has not yet occurred, and suggest nearby restaurants based on the remaining per diem balance and an average meal price.

In some embodiments, the transaction management service synchronizes or otherwise receives calendar data from the user's calendar app, and/or other apps installed on the user's device, this calendar data may be used as attribute and/or context data. Transactions may be pre-approved based on the events in the user's calendar. For example, the user's calendar may include a client meeting off-site; and the transaction management service receives a transaction for an UBER® from the user's office to another location, right before the scheduled client meeting, the context is time proximity to the scheduled event and/or drop off location. Therefore, the transaction may be approved based on the time or location context. In another example, if the client meeting, such as lunch, is approved, the UBER® transaction to the restaurant may inherit the approval from the other transaction.

In another example, an employee submits a request for a trip to San Francisco, so approval of the trip may the genesis of all the transactions related to the trip. The trip approval may be an attribute for the transaction associated with the airfare, and/or the trip approval may be attribute for the transaction associated with the hotel cost. The trip approval may be an attribute that is attached to all transactions related to the approved trip to San Francisco, the related transactions may be automatically approved—within reason. That is to say, there may be rules that define what is “within reason.” The rules could also be determined using historical data. For example, other employee expenses for similar transactions, and/or the employee's previous behavior and/or transaction data. Abnormal behavior may trigger an alert to the user and/or the approver. In other words, attribute and/context data associated with the first transaction, may be attached to other related transactions, so the context data is being built into the transactions as they evolve, and may also gather other transactions that are in proximity. Context information may be gathered from one or more systems/devices pertaining to the transaction. For example, the transaction management system may gather time and location data from the user's device and budget data from the employer's system.

Not all transactions may be conducted using an instrument associated with the transaction management system/application. For instance, the user may use a personal credit card or cash for certain transaction and the user must manually enter the transaction information (e.g., where, when, amount, etc.). However, the transaction management service may enhance the user's experience by allowing the user to snap a picture of the receipt with their smart device and pre-populating fields based on the picture of the receipt. Additionally, if the user enters the transaction information in real-time, context data may be used to pre-populate the fields. Continuing the example described above, the user pays for the taxi ride using cash, the user enters the transaction while sitting in the lobby at the client site, the system can determine the user's location as context data, and pre-populate some of the information fields (e.g., who (employee, department, organization), where, when).

The service may use context information to pre-populate as many fields as possible. In another example, if the user is entering the transaction the next day after the meeting, the user enters a date for the transaction, the service references the user's calendar to determine the user's appointments/meeting for the entered date. If the user only had one meeting that day, the service can pre-populate the fields based on that meeting. In other examples, if the user had multiple meetings, the service may be able to provide a drop-down menu when there are multiple possible inputs. In yet other examples, the service may auto-complete entries for the user.

Additionally, the service may allow the user to add attendees, which may allow the expense to be split (e.g., allocated) among multiple employees. For example, if the multiple employees attend a conference and then have lunch together, instead of requesting separate checks, one employee could pay for the lunch, and the cost would be apportioned among the attendees. In addition to adding attendees, transaction may be apportioned among different accounts and/or clients. For example, if an employee travels out of state to visit two customer sites, the plane ticket and hotel accommodations may be split and separately billed to each client the employee visits.

The manager or approver user may have a separate UI/app for viewing and approving/denying transactions.

Transactions may be made visible only when they are eventually submitted. Further, the budget may not be updated until the amount is paid. Therefore, the transaction may not be visible to the accounting or other systems (e.g., project management) until it is submitted/settled. Traditional budgeting systems do not deduct expense items from the budget at the occurrence of the transaction, this delay reduces the visibility of transactions and creates a fragmented approach to transaction management, one for accounting, one for approval, one for budgeting, and one for fraud handling.

A technical effect provided by the technology disclosed herein is the ability to integrate a payment method with the transaction management service. More specifically, the technology streamlines transaction tracking for both the submitter and the approver. In addition to the transaction management service increases fraud protection.

A number of examples will illustrate the operation of the transaction management system.

In a first example, the transaction management system may attach attribute/context data to invoices and/or transactions. For instance, if an invoice is approved, the subsequent transaction associated with the invoice may inherit the approval of the invoice. The system may match the invoice to the transaction using attribute data, for example vendor ID, amount, delivery date, description, etc.

In another example, the transaction management system may automate expense item approval, in order to limit the amount of human interaction required to process expense items. Context inheritance may also reduce the processing burden on the system, as expense items are automatically approved.

Another example includes, the transaction management system using price data (historical and/or current) to estimate costs and place provisional expense items on the budget), which allows for early visibility of transactions (e.g., encumbrance on the budget). Early visibility also improves fraud detection.

In some embodiments, the transaction management service comprises a context database and engine. The context database and engine establish a context between a user and the payment event. The established context drives the behavior of the transaction management system. For example, the context may determine whether a transaction is automatically approved by the system or if approval from an approver user is required. The context database may by updated as transactions occur, and approval is received. For example, a user may have several pending/submitted transactions in the database. One transaction may be approved, causing the system to be updated with the remaining “pending” records approved based on the context of the approved record.

In the transaction management system, a credit card or other payment instrument is commonly issued to the user. In some embodiments the payment instrument may not be active until a certain event has occurred. For example, the issued credit card may become active once the time for the flight has occurred but be inactive prior to the flight. Additionally, the credit card may become inactive upon the occurrence of an event or after a specified time. Moreover, the payment instrument may become active with a certain amount available.

In the transaction management system, each time a transaction occurs using the issued payment instrument, the transaction can automatically show up in the app on the user's device. A user may attach a receipt. Contrasted with traditional transaction management, where a user completes a transaction and receives a statement from the bank later. With the auto stream, the processor receives notification and data related to a transaction when the transaction occurs, and the transaction shows up in the app on the user's device.

In some embodiments, a method of providing transaction management, the method comprising:

receiving transaction data for approval, wherein the transaction data includes attribute data;

deriving the context information for the transaction data from at least one of a financial institution associated with the transaction data, a vendor associated with the transaction data, a user associated with the transaction data, and/or an employer associated with the user;

determining whether to approve the transaction data based on at least one of the attribute data and the derived context information; and

in response to the transaction data being pre-approved, updating a record associated with the transaction data to indicate the approval.

Aspects include wherein the context information comprises a location of the user.

Aspects include wherein the location of the user is determining using GPS on a device associated with the user.

Aspects include wherein the context information comprises budget information from the employer.

Aspects include wherein the context information comprises a time of year.

Aspects include wherein the context information comprises a Merchant Category Code (MCC).

Aspects include wherein the attribute data includes state data, wherein the state data comprises one of: authorized, approved, declined, adjusted, or settled.

Aspects include wherein the transaction data comprises multiple authorizations associated with a single settlement amount.

Aspects include wherein the transaction data comprises multiple settlements associated with a single authorization amount.

In an embodiment, a method comprising:

receiving by a microprocessor and from a computing device, a transaction for approval;

updating transaction data associated with the transaction to indicate that the transaction has a first state;

processing, by the microprocessor, a set of authorization rules;

determining, by the microprocessor, whether to pre-approve the transaction based on the set of authorization rules;

in response to the transaction not being pre-approved, submitting, by the microprocessor, the transaction for approval;

in response to the transaction being pre-approved, not submitting, by the microprocessor, the transaction for approval; and

thereafter updating transaction data to change a state of the transaction from the first state to a different second state.

Aspects include wherein the set of authorization rules comprise inheritance of approval from another purchase transaction.

Aspects include wherein the set of authorization rules comprise a context based on time.

Aspects include wherein the transaction being submitted for approval comprises an approval user approving the transaction.

Aspects include:

requesting additional information from a user; and

processing, by the microprocessor, the additional information to determine whether the pending payment should be approved.

Aspects include:

processing a user's transaction data to determine upcoming events; and

notifying the user of the upcoming events.

Aspects include:

tracking an amount remaining on a per diem basis; and

making suggestions based on the amount remaining.

Aspects include wherein the suggestions comprise restaurant suggestions.

Aspects include:

receiving a rating for a merchant; and

storing and aggregating the rating for each individual merchant.

In an embodiment, a method of providing discrete and separate notifications for an application running on a communication device, the method comprising:

maintaining multiple counters associated with multiple notifications from multiple channels within the application; and

displaying an application launch associated with the application, wherein the application launch icon is able to simultaneously display multiple badges associated with the multiple notifications.

Aspects include wherein each different notification has a different color.

In an embodiment, a method, comprising:

receiving a balance inquiry associated with a transaction, wherein the balance inquiry is associated with a first company in a plurality of companies, wherein plural parallel processing threads are currently processing different balance inquiries for the different companies, and wherein each of the processing threads corresponds to a different one of the plurality of companies;

comparing selected information in the received balance inquiry with plural sets of information associated with the plurality of companies to determine that the balance inquiry is associated with the first company;

processing the received balance inquiry in a first processing thread of the plurality of parallel processing threads associated with the first company; and

updating transaction data associated with the transaction to reflect an output of the first processing thread.

Aspects include the balance inquiry is associated with a first employee of the first company in a plurality of employees of the first company, wherein plural parallel processing threads are currently processing a different balance inquiry associated with the first company, and wherein each of the processing threads corresponds to a different one of the plurality of employees and further comprising:

processing, by the plurality of employee processing threads, the received balance inquiry to determine that the received balance inquiry corresponds to the first employee.

Aspects include in each of the plural processing threads for the plurality of companies, a hash of a private account number associated with each of the plurality of companies is compared against the selected information in the received balance inquiry and wherein, in each of the plural processing threads for the plurality of employees, a hash of a communication address associated with each of the plurality of first company employees is compared against the selected information in the received balance inquiry.

Aspects include:

comparing a transaction category associated with a budget for the first employee against a transaction category associated with the received balance inquiry to determine whether to approve the received balance category for payment;

comparing a date range associated with the budget life with a timestamp of the transaction to determine whether the budget is active to authorize payment of the received balance inquiry; and

comparing an amount of the budget with an amount of the transaction to determine whether the budget has adequate funds to authorize payment of the received balance inquiry.

In an embodiment, a method, comprising:

receiving transaction data relating to a selected transaction and a budget for the selected transaction, the selected transaction and budget being associated with an identified first user;

applying, by a rules engine, a set of deterministic rules to the transaction data to provide a first outcome for the selected transaction;

applying, by the rules engine, a set of heuristic rules to the transaction data to provide a second outcome for the selected transaction;

processing, by a machine learning module and using learnings, the first and second outcomes to provide a third outcome of the transaction;

receiving input from a human reviewer to convert the first, second, and third outcomes into a final outcome; and

updating the learnings to comprise the final outcome to be applied by the machine learning module to a future transaction.

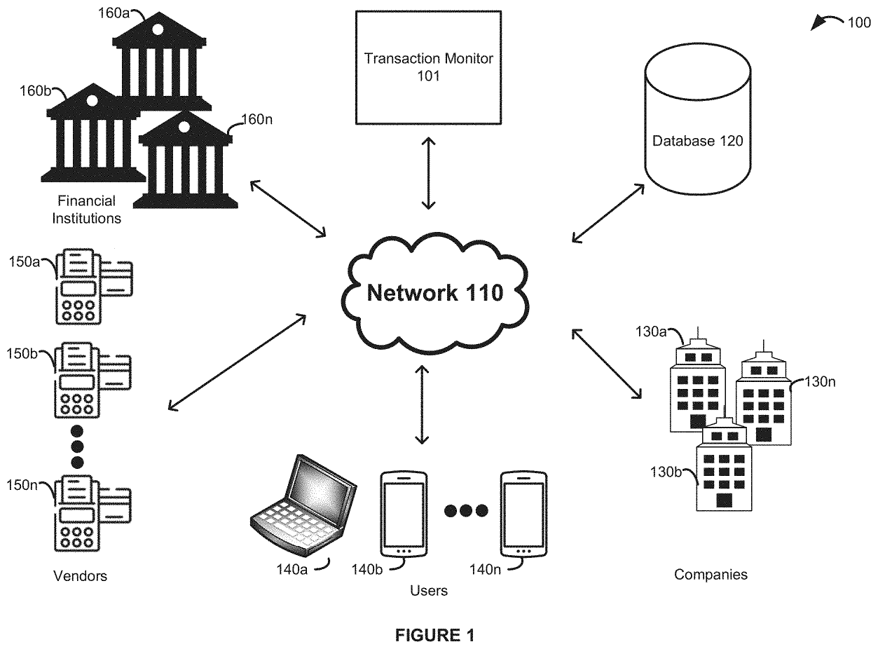

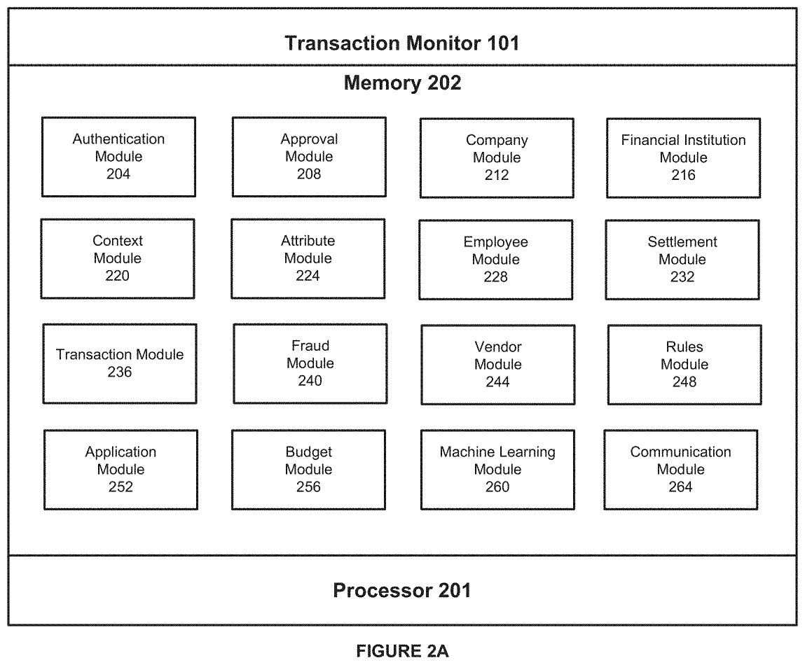

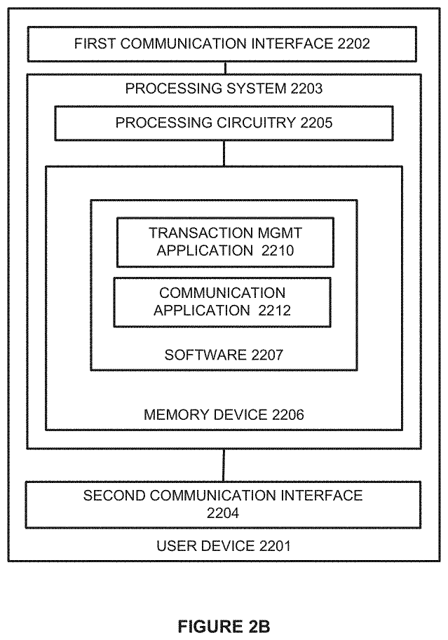

Referring now to FIG. 1, a system 100 is depicted for managing, tracking, approving, and reimbursing transactions. The system 100 includes one or more components, which may be hardware and/or software that can be included in one or more computer systems, as described with FIGS. 2A and 2B. The system 100 includes a transaction monitor 101, a network 110, a database 120, one or more companies 130a-n, one or more users and their associated user devices 140a-n, one or more vendors 150a-n, and one or more financial institutions 160a-n. Each of these components will be described hereinafter.

A user device 140a-n can be any computer system or device used by a person or entity seeking to provide transaction information to the transaction monitor 101. Thus, the user device 140 may be represented by a laptop or desktop computer 140a, a user mobile device 140b, or one or more other types of user devices (e.g., wearable devices, tablets, etc.). There may be more or fewer user devices than those shown in FIG. 1, as represented by ellipses. A user can be any person, whether a person (e.g., employee) or organization, that enters transaction/transaction data. The user devices 140a-n can communicate with a network 110 to send or receive data or other communications to/from the transaction monitor 101. The user devices 140a-n may be associated with users (not shown) employed by or otherwise associated with the companies 130a-n.

The vendor devices 150a-n are associated with vendors that provide services/goods to users (e.g., airlines, restaurants, hotels, car rentals, transportation services, etc.). The vendor devices 150a-n are associated with a computer system or device, such as a point service device that processes transactions for the vendors 150a-n.

Financial institutions 160a-n issue physical or digital instruments (e.g., cash, check, credit card, etc.) to companies 130a-n and/or users for completing or reimbursing transactions. Financial institutions 160a-n may be companies that issue the instruments (e.g., provide authorization) and/or the entities that provide physical or electronic payment.

A network 110 can be any distributed processing network used to communicate information between two or more computer systems. The network 110 may include any type of known communication medium or collection of communication media and may use any type of protocols to transport messages between devices. In embodiments, the network 110 may also represent phone systems or other means of communicating information from a user device to the transaction monitor 101 and/or other components, from the companies 130a-n to the transaction monitor 101 and/or other components, from the vendors 150a-n to the transaction monitor 101 and/or other components, from the financial institutions 160a-n to the transaction monitor 101 and/or other components. Thus, the network 110 can represent systems or networks for completing transactions or other types of communication systems. The network 110 can be an intranet, the Internet, the World Wide Web, etc. In other embodiments, the network 110 may be a public switched telephone network (PSTN) or other type of phone system.

The network 110, in some embodiments, may also include a WAN or LAN. Alternatively, or additionally, the network 110 may include one or more devices that are not administered by the same entity administering the transaction monitor 101. Thus, the network 110 may be considered an untrusted or unsecure network from the perspective of the transaction monitor 101. The Internet is an example of the network 110 that constitutes an IP network consisting of many computers, computing networks, and other communication devices located all over the world, which are connected through many telephone systems and other means. Other examples of the network 110 include, without limitation, a standard Plain Old Telephone System (POTS), an Integrated Services Digital Network (ISDN), the Public Switched Telephone Network (PSTN), a cellular network, and any other type of packet-switched or circuit-switched network known in the art. In some embodiments, the network 110 may be administered by a Mobile Network Operator (MNO).

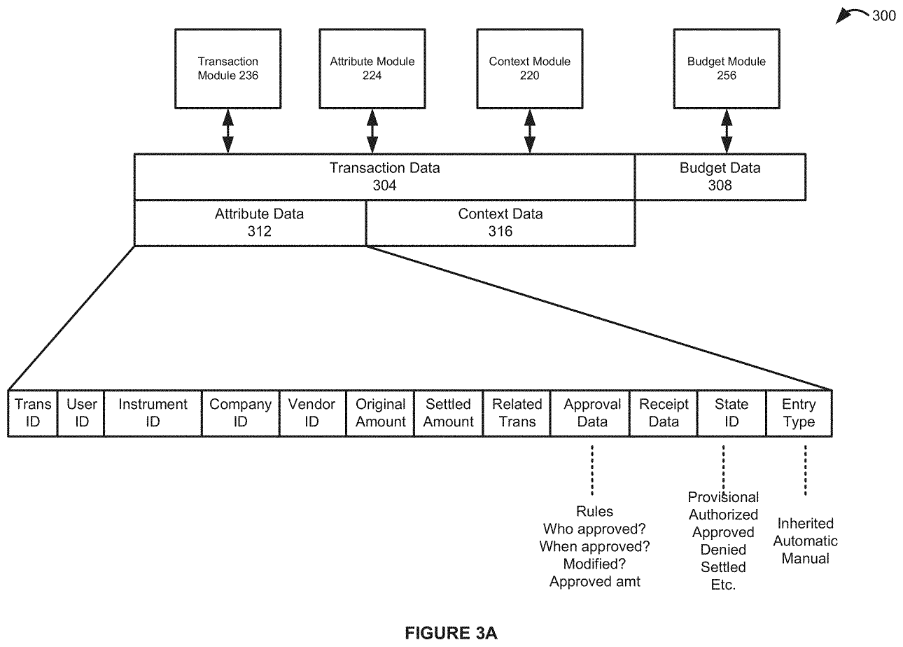

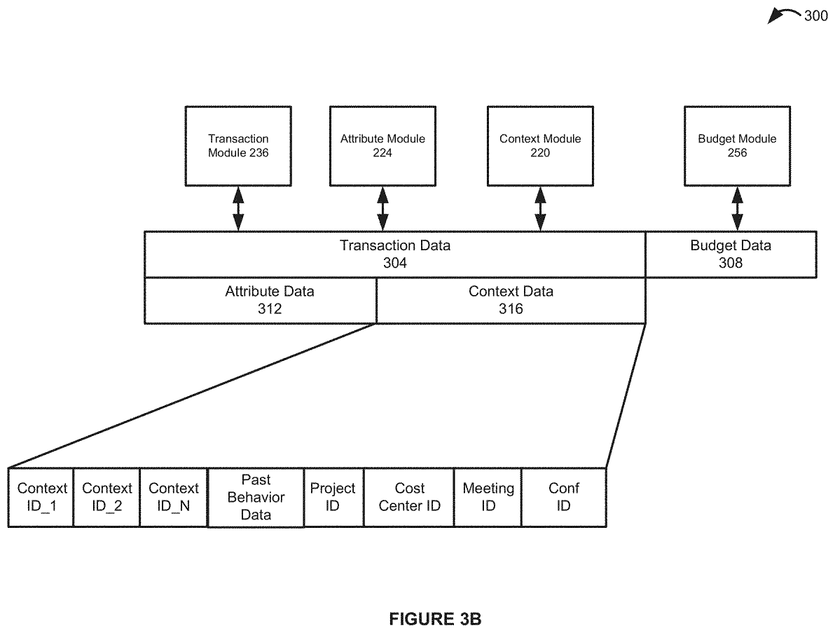

The database 120 can be any database or storage system as described in conjunction with FIG. 1. The database 120 can store information as described in conjunction with FIGS. 3A-B, 4, 6, 7, and 8B, and the database 120 can store budget data. The database 120 may store this information in one of several different formats or by different methods, for example, a relational database, a flat file database, an object-oriented database, etc. The database 120 may allow the transaction monitor 101 to both store and retrieve data for processing transactions. In some embodiments, the database 120 may be a part of the transaction monitor 101, as appropriate, or may be a separate storage system that is in communication with the transaction monitor, as appropriate, but does not store information locally.

The transaction monitor 101 can be any hardware and/or software operable to perform the methods, systems, and services described herein.

An embodiment of the transaction monitor 101 is described in conjunction with FIG. 2A, which is representative of any system or collection of systems in which the various applications, services, scenarios, and processes disclosed herein may be implemented. Transaction monitor 101 may be employed to execute a transaction management service, such as the one described herein.

The transaction monitor 101 includes a number of processor readable software modules that, when executed by the processor, perform functions described herein. The transaction monitor 101 includes an authentication module 204 that securely authenticates users, vendors, companies, etc., using one or more single-factor or multi-factor authentication indicia. Exemplary indicia comprise something the object knows, something the object has, and something the object is. The transaction monitor 101 includes an approval module 208 that approves or denies transactions received by the transaction monitor 101. The transaction monitor 101 includes a company module 212 that processes information associated with various companies, such as companies 130a-n, which utilize the transaction management system/service. The information can include, for example, budget information (e.g., an item or transaction-specific budget or a budget for a plurality of items or transactions), employee information, and vendor information. The transaction monitor 101 includes a financial institution module 216 to interact with financial institutions, such as financial institutions 160a-n issuing physical or digital financial instruments used to complete transactions. The transaction monitor 101 includes a context module 220 for determining context data for transactions (including a context feedback loop). The transaction monitor 101 includes an attribute module 224 for determining attribute data for transactions. The transaction monitor 101 includes an employee module 228 for processing employee information. Examples of employee information include employee identity (e.g., name, social security number, home address, vehicle license or registration information, travel preferences, etc.), electronic calendar information (e.g., appointment information on an OUTLOOK™ calendar, etc.), presence information (e.g., any status indicator that conveys the spatial location, ability, and willingness of a person to communicate), device 140 information (e.g., device identifier such as serial number, electronic communication address, etc.), hierarchy information (e.g., position of employee within a company), and the like. The transaction monitor 101 includes a settlement module 232 for processing transaction settlement data. The transaction monitor 101 includes a transaction module 236 for processing transactions. The transaction monitor 101 includes a fraud module 240 for detecting fraudulent activity. The transaction monitor 101 includes a vendor module 244 for processing vendor information, such as vendor information associated with vendors 150a-n. Exemplary vendor information includes vendor identity (e.g., name, tax identifier, primary physical address, etc.), device information (e.g., device identifier such as serial number, electronic communication address, etc.), geographical information (e.g., geographical location of vendor stores, offices, etc.), vendor offered service or product description (e.g., bar code, RFID identifier, universally unique identifier, globally unique identifier, QR code, etc., of a product or service), and the like. The transaction monitor 101 includes a rules module 248 for processing transactions. The transaction monitor 101 includes an application module 252 for providing the transaction management applications to devices. The transaction monitor 101 includes an advertisement module 256 for providing advertisement information, such as from vendors, to user and company computational devices 140 and 130. The transaction monitor 101 includes a machine learning module 260 that learns from previous transactions and creates and augments context data, rules, and/or learnings to continually improve the transaction management system. The context module 220 can apply deterministic rule sets and heuristic rule sets provisionally approve or deny transactions. The transaction monitor 101 includes a communication module 264 that enables inter-device communications between the transaction monitor 101 on the one hand and devices associated with the financial institutions, vendors, companies, and the database on the other. The various modules are in communication via a signal transmission medium, such as a bus, local network, wide area network, and the like.

The communication module 264, when executed by the processor, may enable the transaction monitor 101 to communicate with the other devices in the system 100. For instance, the communication module 264 may be configured to modulate/demodulate communications exchanged over the network 110, determine timings associated with such communications, determine addresses associated with such communications, etc. In some embodiments, the communication module 264 may be configured to allocate communication ports of the transaction monitor 101 for use as a communication interface. The communication module 264 may further be configured to generate messages in accordance with communication protocols used by the network 110 and to parse messages received via the network 110.

Transaction monitor 101 may be implemented as a single apparatus, system, or device or may be implemented in a distributed manner as multiple apparatuses, systems, or devices. Transaction monitor 101 may include other components omitted for clarity.

Processor 201 loads and executes modules from memory 202. Modules includes authentication module 204, approval module 208, company module 212, financial institution module 216, context module 220, attribute module 224, employee module 228, settlement module 232, transaction module 236, fraud module 240, vendor module 244, rules module 248, application module 252, budget module 256, machine learning module 260, and communication module 264, which are representative of the software applications discussed with respect to the FIGS. 1 and 3-19, including the transaction management service. When executed by processing system 201, the modules direct the processor 201 to operate as described herein for at least the various processes, operational scenarios, and sequences discussed in the foregoing implementations to integrate transaction management. Transaction monitor 101 may optionally include additional modules, devices, features, or functionality not discussed for purposes of brevity.

Memory 202 may comprise any computer readable storage media readable by processor 201 and capable of storing the modules. Memory 202 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations memory 202 may also include computer readable communication media over which at least some of the modules may be communicated internally or externally. Memory 202 may be implemented as a single storage device but may also be implemented across multiple storage devices or sub-systems co-located or distributed relative to each other. Memory 202 may comprise additional elements, such as a controller, capable of communicating with processor 201 or possibly other systems.

The modules may be implemented in program instructions and among other functions may, when executed by the processor 201, direct the processor 201 to operate as described with respect to the various operational scenarios, sequences, and processes illustrated herein. In particular, the program instructions may include various components or modules that cooperate or otherwise interact to carry out the various processes and operational scenarios described herein. The various components or modules may be embodied in compiled or interpreted instructions, or in some other variation or combination of instructions. The modules may include additional processes, programs, or components, such as operating system software, virtual machine software, or other application software. Transaction monitor 101 may include other software such as firmware or some other form of machine-readable processing instructions executable by the processor 201.

In general, the modules may, when loaded into processor 201 and executed, transform a suitable apparatus, system, or device overall from a general-purpose computing system into a special-purpose computing system customized to enhance transaction management operations. Indeed, encoding modules on memory 202 may transform the physical structure of memory 202. The specific transformation of the physical structure may depend on various factors in different implementations of this description. Examples of such factors may include, but are not limited to, the technology used to implement the storage media of memory 202 and whether the computer-storage media are characterized as primary or secondary storage, as well as other factors.

For example, if the computer readable storage media are implemented as semiconductor-based memory, the modules may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication between transaction monitor 101 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. In any of the aforementioned examples in which data, content, or any other type of information is exchanged, the exchange of information may occur in accordance with any of a variety of well-known data transfer protocols.

It should be appreciated that the instruction sets depicted in FIG. 2A may be combined (partially or completely) with other instruction sets or may be further separated into additional and different instruction sets, depending upon configuration preferences for the transaction monitor 101. Said another way, the particular modules depicted in FIG. 2A should not be construed as limiting embodiments described herein.

With reference now to FIG. 2B, additional details of a user device 2201 will be described in accordance with embodiments of the present disclosure. The user device 2201 is an example of user devices 140a-n. Examples of user device 2201 include, but are not limited to, mobile devices, smart phones, wearable computing devices, gaming devices, personal computers, mobile phones, tablet computers, desktop computers, laptop computers, and any other type of computing system (or collection thereof) suitable for carrying out the optimization operations described herein. Such systems may employ one or more virtual machines, containers, or any other type of virtual computing resource in the context of supporting a transaction management service.

The user device 2201 is shown to include a processing system 2203, processing circuitry 2205, memory device 2206, and first and second communication interfaces 2202 and 2204. The memory device 2206 may store software 2207. Software 2207 may include transaction management application 2210. These resources may enable functionality of the user device 2201 as will be described herein. For instance, the first communication interface 2202 may provide the user device 2201 with the ability to send and receive communication packets or the like over the network 110 to the transaction monitor 101. The first communication interface 2202 may be provided as a network interface card (NIC), a network port, drivers for the same, and the like. Communications between the components of the user device 2201 and other devices connected to the network 110 may all flow through the first communication interface 2202.

The user device 2201 is also shown to include a second communication interface 2204 that facilitates communications with a user. Second communication interface 2204 comprises components that interact with a user to receive user inputs and to present media and/or information. Second communication interface 2204 may include a speaker, microphone, buttons, lights, display screen, touch screen, touch pad, scroll wheel, communication port, or some other user input/output apparatus—including combinations thereof. Second communication interface 2204 may omitted in some examples.

The processing system 2203 may correspond to one or many computer processing devices. For instance, the processing system 2203 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processing system 2203 may be provided as a microcontroller, microprocessor, Central Processing Unit (CPU), or plurality of microprocessors that are configured to execute the instructions sets stored in memory device 2206. Upon executing the instruction sets stored in memory 2206, the processing system 2203 enables various functions of the user device 2201.

The memory device 2206 may include any type of computer memory device or collection of computer memory devices. The memory device 2206 may include volatile and/or non-volatile memory devices. Non-limiting examples of memory device 2206 include Random Access Memory (RAM), Read Only Memory (ROM), flash memory, Electronically-Erasable Programmable ROM (EEPROM), Dynamic RAM (DRAM), etc. The memory device 2206 may be configured to store the instruction sets depicted in addition to temporarily storing data for the processing system 2203 to execute various types of routines or functions.

The illustrative instruction sets that may be stored in memory device 2206 include, without limitation, the transaction management application 2210. Although not depicted, the memory device 2206 may include instructions that enable the processing system 2203 to store data into a database 120 and retrieve information from the databases.

In some embodiments, the transaction management application instruction set 2210, when executed by the processing system 2203, may enable the user device 2201 to execute the transaction management application. In some embodiments, the transaction management application instruction set 2210 may include subroutines that perform various functions.

In some embodiments, the transaction management application instructions set 2210, when executed by the processing system 2203, may enable the user device 2201 to track one or more transaction of the user and notify the user of alerts associated with the transaction management application.

The communication instruction set 2212, when executed by the processing system 2203, may enable the user device 2201 to communicate with the other devices in the system 100. For instance, the communication instruction set 2212 may be configured to modulate/demodulate communications exchanged over the network 110, determine timings associated with such communications, determine addresses associated with such communications, etc. In some embodiments, the communication instruction set 2212 may be configured to allocate communication ports of the user device 2201 for use as either the first or second communication interface 2202 and/or 2204 as appropriate. The communication instruction set 2212 may further be configured to generate messages in accordance with communication protocols used by the network 110 and to parse messages received via the network 110.

FIG. 3A depicts a data structure 300 according to an embodiment. The data structure, which can be stored in memory 202 of the transaction monitor 101 and/or the database 120 stores transaction data 304 and budget data 308 associated with a transaction. Transaction data 304 comprises attribute data 312, which includes transaction ID, user ID (e.g., who initiated the transaction), instrument ID (e.g., credit card number), company ID (e.g., employer), vendor ID, original amount, settled amount, related transaction(s), approval data generated as a result of applying rule sets for approving transactions (e.g., approval chain—who approved the transaction/item, modifications to the transaction data 304 made during the approval process, timestamp of approval event, approved amount for the transaction/item, etc.), receipt data, state ID (e.g., provisional approval of transaction/item, final approval of transaction/item, approval pending, transaction/item submitted for approval, approval denied for the transaction/item, transaction/item settled, timestamp associated with each event, etc.), and data entry type (e.g., inherited, automatic, or manual). The proceeding fields are provided for illustrative purposes only and are not meant to limit the fields that may be included the attribute data.

FIG. 3B depicts a data structure 300 according to an embodiment. The data structure, which can be stored in memory 202 of the transaction monitor 101 and/or the database 120 stores context information, and includes context IDs 1-N (e.g., cost center, project, department, client), past behavior data, project ID, cost center ID, meeting ID, conference ID, etc. The proceeding fields are provided for illustrative purposes only and are not meant to limit the fields that may be included in the context.

In some embodiments, the transaction data in the context ID fields includes context data 316, such as, but not limited to employee information with respect to the employee initiating the transaction, vendor information with respect to the vendor involved in the employee-initiated transaction, company information with respect to the company associated with the employee, timestamp of the transaction, transaction geographic location, type of transaction (e.g., hotel, airline, restaurant, employee transportation service (e.g., taxi, UBER™, LYFT™, etc.), product or service identifier associated with the product or service, payment type (e.g., cash or credit card), weather in the transaction geographic location at the timestamp of the transaction, and the like.

While not shown in the figures, the smallest container in any of the attribute data 312 or context data 316 is an event. Events are tracked and recorded by the transaction monitor 101 in connection with or separate from the attribute data 312 or context data 316. Events refer to any event that is tracked with relation to a user or transaction.

Transactions may be settled against a budget for the company, department, employee, project, time period, etc. Budget data includes, but is not limited to, owner ID, context ID, time period, amount, modified amount, modifier event, etc.

In some embodiments, transactions may include attributes such as, but not limited to, transaction ID, user ID (e.g., who initiated the transaction), instrument ID (e.g., credit card number), company ID (e.g., employer), vendor ID, the original transaction amount, the current settlement amount, related transaction(s), approval data (e.g., approval chain—who approved, what was his or her role in the approval, when did he or she approve it, did the approver modify the transaction amount), receipt data, state ID (e.g., approved, pending, denied, settled, etc.), and entry type (e.g., inherited, automatic, or manual).

In some embodiments, transactions may also include context data, such as, but not limited to, one or more context IDs (e.g., cost center, project, department, client), past behavior data, project ID, cost center ID, meeting ID, conference ID, etc. Transactions may be settled against a budget for the company, department, employee, project, time period, etc. Budget data includes, but is not limited to, owner ID, context ID, time period, amount, modified amount, modifier event, etc.

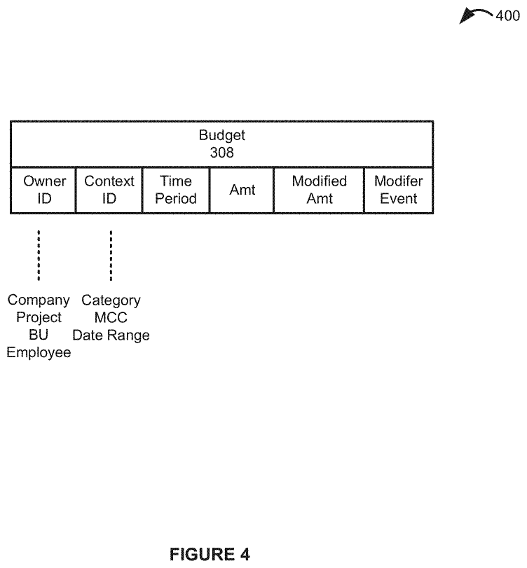

FIG. 4 depicts the budget data 308 structure 400 according to an embodiment. The data structure 400, which can be stored in memory (not shown) of the transaction monitor 101 and/or the database 120 stores budget data associated with a specific transaction or item or group of multiple transactions or items, and includes owner ID (e.g., individual (e.g., employee or consultant), project, or department or business unit that is authorized to use the budget) and his or her device ID, context ID (e.g., ID of context associated with transaction or expense item, which can include a context category, such as MCC, and a date range associated with the context ID), time period (e.g., monthly, quarterly, yearly, etc.) in which to use the budget on the associated transaction(s) or items(s), budget limit amount associated with a specific transaction or item or group of multiple transactions or items, modified budget amount (e.g., increase or decrease budget amount), available funds, or remaining budget balance, for the associated transaction(s) or items(s), modifier event (e.g., added new employees to the department), a vendor ID of an approved vendor for the associated transaction(s) or items(s), a location ID of a geographical location in which to complete associated transaction(s) or items(s), a predetermined product or service identifier of the associated transaction(s) or items(s), preconditions based on the use of the budget to complete the associated transaction(s) or purchase the associated item(s) (e.g., requisite weather, time of year, geographic location, and the like).

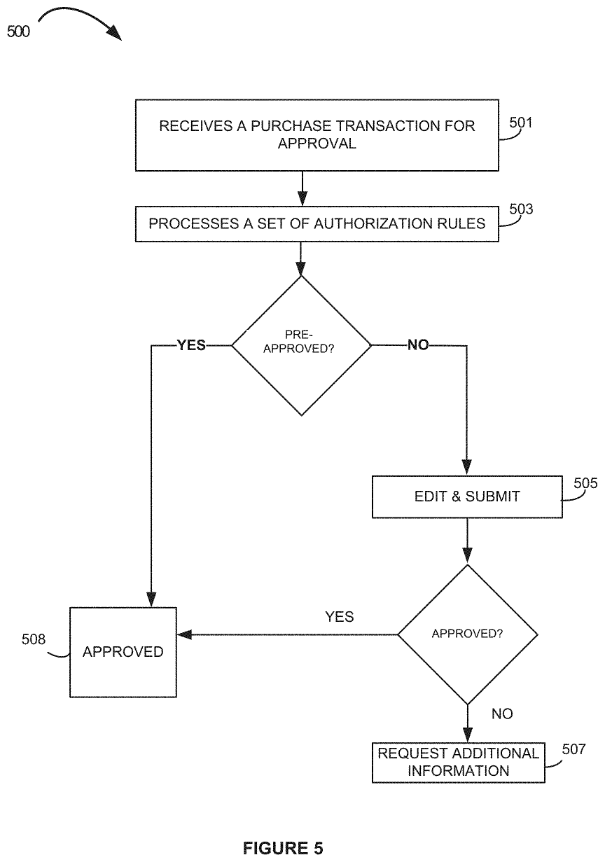

In accordance with some embodiments, the operation of the transaction management system 100 will now be discussed with reference to FIG. 5, which shows the logic step sequence 500.

To begin, the transaction management service receives a purchase transaction for approval (step 501). For example, a user that has been issued a credit card associated with the transaction management service makes a purchase transaction using the issued credit card. Since the credit card was issued by the same entity running the transaction management service, the purchase transaction information may be sent to the transaction management service in real-time. Similar to a transaction posting to a user's bank account, the purchase transaction may post to the transaction management service.

Next, the transaction management service processes a set of authorization rules to determine if the transaction should be pre-approved (step 503). In some embodiments, the authorization rules may comprise approval inheritance. In other words, certain transactions may inherit approval from another transaction. For example, a transaction associated with a hotel reservation may inherit approval from the approved transaction associated with a flight reservation. In other examples, a transaction may be approved based on context. For instance, context may comprise a time window that encompasses an approved event. Considering the previous example, assuming that a flight reservation is approved, the taxi ride to the airport for the flight may be approved based on context. In another example, context may comprise calendar information. If a user has a client meeting scheduled from 12:30-2:00 pm on Oct. 1, 2019, and a purchase transaction for ELWAYS® is submitted at 2:05 pm on Oct. 1, 2019, the transaction may be approved based on context. In some embodiments, the transaction management service may have access to other applications running on the device, such as e-mail, calendar, text messaging, social media, etc.

If the transaction is pre-approved, the process flow goes to approved (step 508), and no further action is needed from the submitter or the approver. If the purchase transaction is not pre-approved, process flows to step 505, where the user can edit the transaction prior to submittal. In some examples, the user may add a photo of the receipt. Additionally, or alternatively, the user may edit the transaction by adding/changing fields, such as “purpose,” “date,” “attendee(s),” etc. The proceeding fields are provided for illustrative purposes only and are not meant to limit the fields that may be included in a purchase transaction.

Once the user completes the edits, the transaction is submitted to an approver user for approval. If the transaction is approved, the process concludes at step 508. If the transaction is denied, the approver may request additional information from the user (step 507). For example, some transactions may be approved even without documentation such as a receipt, however, if a receipt is determined to be required, it may be requested at step 507.

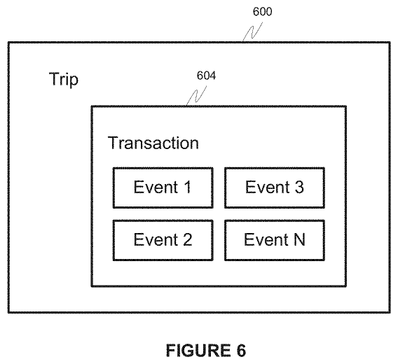

FIG. 6 illustrates a trip transaction tuple or container 600 that includes one or more transaction fields 604 corresponding to one or more transactions, the transactions have associated event/context information in fields event 1 . . . n. For example, an employee submits a request for a conference in Seattle. The conference is approved, so approval of the conference may the genesis of all the transactions related to the conference. The conference approval may be an attribute for the transaction associated with the airfare, and/or the trip approval may be attribute for the transaction associated with the hotel cost.

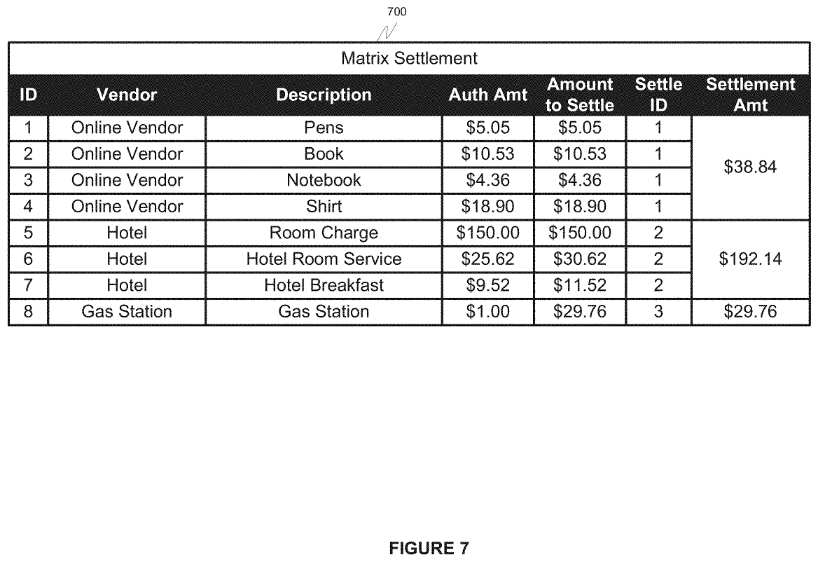

FIG. 7 depicts a data structure 700 according to an embodiment. The data structure, which can be stored in memory 202 of the transaction monitor 101 and/or the database 120, includes transaction ID, vendor ID, description, authorized amount, amount to settle, settlement ID, and settlement amount (e.g., total amount settled).

Matrix settlement is the concept that multiple authorizations may be settled in one settlement, and/or one authorization may result in multiple settlements. That is to say, transactions may be split or joined. This can be extracted all the way up to the invoice level. For example, a transaction, when it occurs can be split across multiple vendors. So, an umbrella organization (e.g., AMAZON™) issues one authorization for the total amount and splits the payment among the multiple vendors. In another example, if a person takes an LIBER®, the trip may result in multiple authorizations for different event (e.g., trip charge, tolls, tip, etc.). These different transactions can settle into one or more funds movement events. So that the proof of payment and the subsequent requests for funds have a many-to-many relationship between them. Stated differently, a single transaction can settle against multiple fund requests, or many transactions can settle against one fund request. Conversely, a person can have multiple authorizations settling to a single transaction. For example, when the person checks into a hotel, the first authorization may be for the room charge. While the person is staying, he or she may order room service or dine in the hotel restaurant, which results in another authorization. Both authorizations may settle in one settlement after check out. Additionally, an initial authorization may settle for a different settlement amount (e.g., authorization for gas is $1.00 and settles for actual amount).

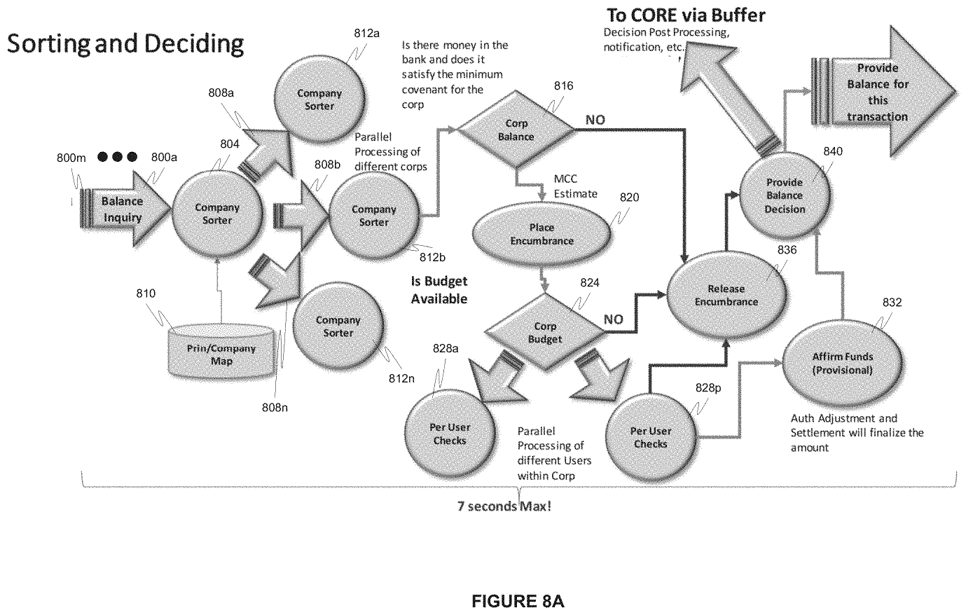

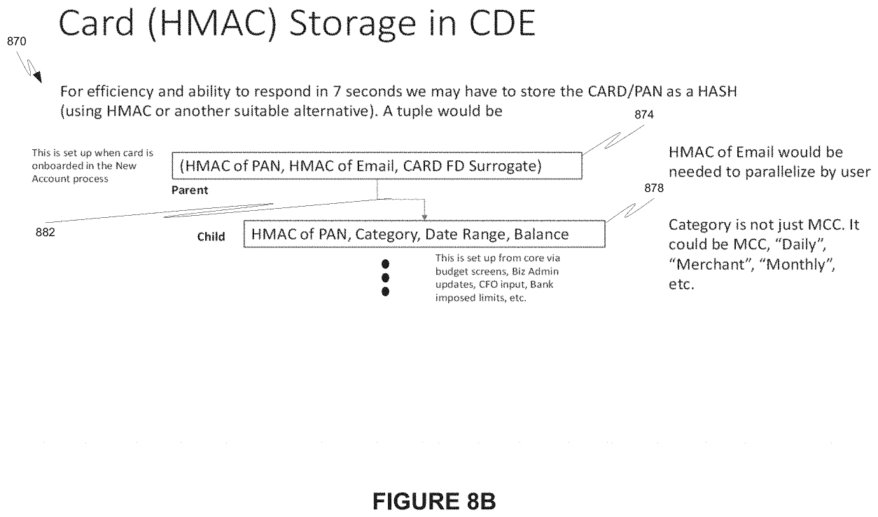

FIGS. 8A-8B illustrate a workflow for sorting and settling multiple transaction simultaneously using parallel, rather than serial, processing. The workflow/process may be used to provide an approval/denial decision on a transaction/balance inquiry in seven seconds or less. Additionally, the workflow may be applied to invoice payments, budget approvals, etc. A data record associated with the transaction is updated with the approval/denial decision.

The sorting and decision mechanism sorts multiple transactions simultaneously and settles each transaction within defined boundaries. Examples of boundaries include, but are not limited to, a credit card balance (may be set by the financial institution issuing the card), an organization/departmental/individual budget (may be set by the employer), other limits (configurable daily, project, etc.). For efficiency, the system may store payment instrument information associated with company data. The company sorting set, determines which company/employer is associated with the transaction, in order to send a request for associated boundary information for company. In some examples, the system may also store the boundary information for each company.

Referring to FIG. 8A, the sorting and deciding process is initiated when one or more balance inquiries 800a-m in connection with a respective transaction is/are received by the transaction monitor 101.

The next step 804 is to sort the balance inquiry by company 130. Each company 130 corresponds to a separate (parallel) processing thread as shown by arrows 808a-n and company sorter threads 812a-n.

The sorting process uses company and user or employee information in database 810 to map a received balance inquiry to a specific company 130. The database 810 can be separate from or part of the database 120. The balance inquiry can take many forms, such as a machine-to-machine command, an email, a text message, or a query received via a user interface of the transaction monitor 101. In any type of balance inquiry, the transaction monitor parses the inquiry for information or metadata that can be mapped against the employee and company information fields in the database 810 to identify a corresponding company and employee or other user associated with that company.

In each of the threads 812a-n, the next step is to determine in decision query 816 if there are funds in the corporate bank account to satisfy a minimum balance requirement of the financial institution 160 after the transaction is paid.

When there are sufficient funds in the bank account, the transaction monitor 101, in step 820, places an encumbrance on the bank account funds required to pay the expense item and the transaction monitor 101, in decision query 824, determines whether there are sufficient uncommitted funds in the corporate budget to cover the expense item.

To verify that sufficient budget is uncommitted to cover the transaction, the transaction monitor 101 initiates further parallel processing threads 828a-p for each user or employee corresponding to the budget to confirm that uncommitted funds are adequate to cover the expense item. While the parallel processing threads 812a-n correspond to the different companies 139, the parallel processing threads 816a-p correspond to different users associated with a selected company corresponding to the respective thread 812b.

When the transaction monitor 101 confirms that there are sufficient remaining uncommitted budget funds to cover the transaction, the transaction monitor 101 in step 832 affirms that the funds are available in both the bank account and budget to cover the transaction and authorizes adjustment and settlement to finalize payment.

When there are not sufficient funds in the bank account (decision query 816) or there are not sufficient uncommitted funds in the budget (decision query 824 and/or step 828) to cover the expense item, the transaction monitor 101 in step 836 releases the encumbrance on the budget as the item will not be settled.

After either step 832 or 836, the transaction monitor 101, in step 840, provides a balance decision for the transaction corresponding to the expense item (step 840) and updates electronic records associated with the transaction in the data base 120.

In some embodiments of the above process, the transaction monitor 101 determines in decision query 816 whether there is enough credit limit available in the bank account, in decision query 824 whether there is enough budget available within a user's individual budget. If there are not enough funds in either the bank account or user's individual budget, then the transaction is denied in step 836. In some examples, the system may use cost/pricing data to estimate the encumbrance, with the estimation later being reconciled with the actual amount of the expense item. Additionally, a code (e.g., Merchant Category Code or MCC) may be attached to transaction. This allows for finer control of budgets. The system provides an authorization decision (e.g., approve or deny). Authorization is separate from settlement.

In some embodiments, the transaction monitor 101 determines a daily average spend statically configured and periodically changed with a support ticket and executes a windowing function to compute a spending trend to adjust a balance based on an expected transaction on a selected day based on past data and requires a balance based on the expected transaction.

In some embodiments, the transaction monitor 101 estimates the transaction amount using an added percentage over the transaction amount based on the MCC to reflect likely additional charges, such as tips, gas, previous usage, etc. The transaction monitor 101 can, in decision query 816, require enough funds to be maintained in the bank account to cover a projected spend of the company based on historical spending patterns over a selected period (e.g., 2.5 days).

Referring now to FIG. 8B, a first data structure 870 is depicted that is used by the process of FIG. 8A in updating transaction-related records and in company sorting (step 804), determining a corporate budget (step 824), employee sorting (step 828), and providing a balance decision (step 840). The data structure 870 can enable rapid processing of balance queries 800a-m. When a personal or company credit card is input into the transaction monitor 101, a parent data structure 874 is created that includes an HMAC hash of a personal account number, which is typically the number of the credit card, an HMAC hash of an email address associated with the credit card (such as the user or the company), and a card token (CARD FD surrogate) representing an alternative identifier for the card. The card token can be determined by any suitable technique, such as by a hash of selected card information, a portion of the credit card number, or other identifier. While the example is explained with reference to an HMAC hash, it is to be understood that any hash algorithm can be employed. Examples of other hash algorithms include, without limitation, Secure Hashing Algorithm (“SHA”)-1, SHA-2, SHA-256, SHA-384, etc. Such cryptographic hash algorithms can produce irreversible and unique hashes. Irreversible means that knowing the hash alone does not enable a computer to determine the original hashed data, thereby enabling the original hashed data to remain secure and unknown. Unique means that two different pieces of data can never produce the same hash. The email address that is hashed is typically an email address of a user that will use the card for a transaction or expense item. The hashed personal account number and email address are used by the parallel threads 804, 812a-n, and 828a-p to rapidly pair up an email in a balance inquiry 800 with a corresponding company 130 and the respective user in the corresponding company associated with the balance inquiry 800.

A second (child) data structure 878 is linked 882 with the first (parent) data structure through the use of the hashed personal account number in the first field of each of the data structures. The second (child) data structure 878 comprises not only the hashed personal account number but also the category field of a transaction or expense item (such as a merchant category code (MCC) or other product information (e.g., bar code, RFID identifier, universally unique identifier, globally unique identifier, QR code, etc., of a product or service), daily, monthly, or other time of recurrence of the transaction or expense item, vendor name or other vendor information, and the like. The second data structure 878 further includes a date range field for the transaction or expense item or budget itself indicating a time period during which the transaction or expense item can be purchased, or the budget used. Any transaction or expense item timestamp outside of this date range is not authorized or, in the case of the budget, any expense against the budget outside of the date range will not be approved. The balance field comprises a balance of the budget as determined by company representatives, such as business administration or management, and/or bank-imposed limits, and/or other factors.

As will be appreciated, the first data structure 874 can be linked with multiple second data structures 878 relating to different transactions or expense items that may be charged against the personal account identifier. The child data structures can each relate to the same transaction or different transactions or budgets involving a common personal account number and email address.

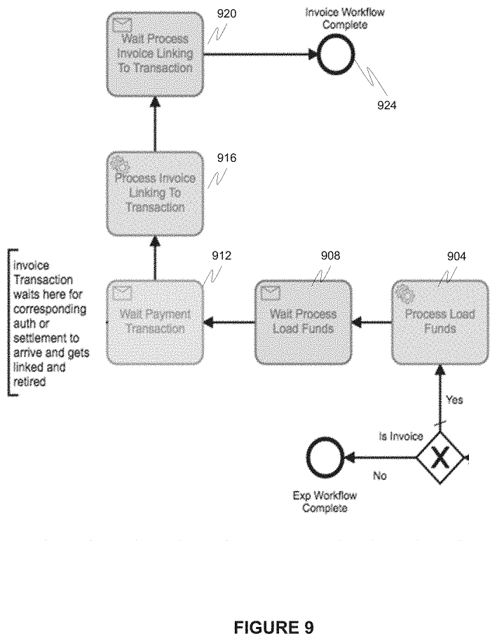

FIG. 9 illustrates a workflow for invoices. The invoice workflow may be similar to the workflow for transactions. For example, invoices may inherit class specific parameters on approval configuration. Transactions, if matched to the invoice, may inherit the attribute/approval/context of the invoice. If there is significant variation between the invoice and the transaction, this may trigger additional review/approval. Upon approval of an invoice, an associated credit card may be configurable to fund the card for the approved amount (“Zero credit limit/balance card”).

Referring to FIG. 9, the transaction monitor 101, in decision diamond 900, after determining that the transaction associated with the invoice has been approved for payment, determines that payment is to be made in response to an invoice from a vendor.

In steps 904 and 908, the transaction monitor 101 initiates a process to load funds electronically to effect invoice payment.

In step 912, the transaction monitor 101 waits to submit payment to the vendor until corresponding authorization or settlement arrives, is linked to the transaction data, and is retired.

Upon receiving corresponding authorization or settlement, the transaction monitor 101, in step 916, completes processing of the invoice by linking the invoice to the transaction data 304 of the transaction associated with the invoice.

In step 920, the transaction monitor 101 waits to process the invoice until the invoice is linked to the transaction data 304 and, in step 924 after the invoice is linked to the transaction data 304, updates the transaction data to note that the invoice workflow is complete.

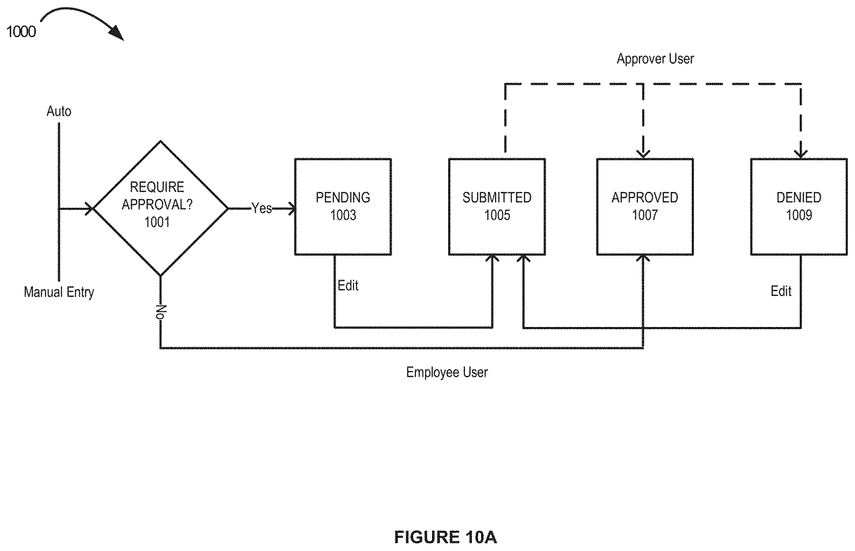

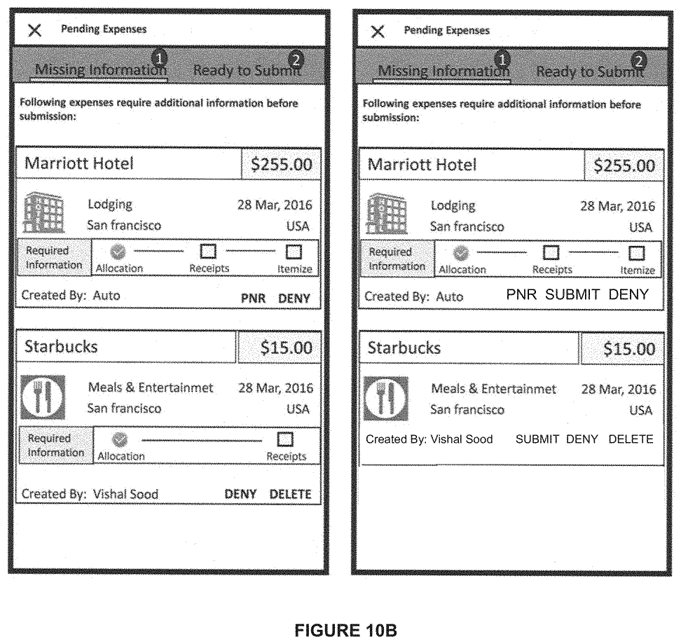

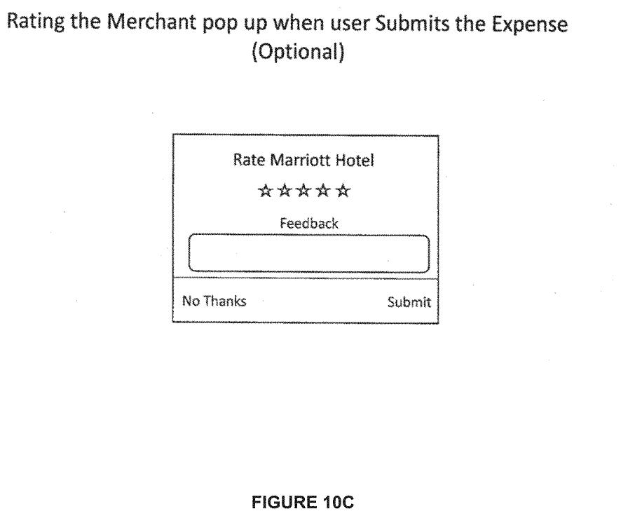

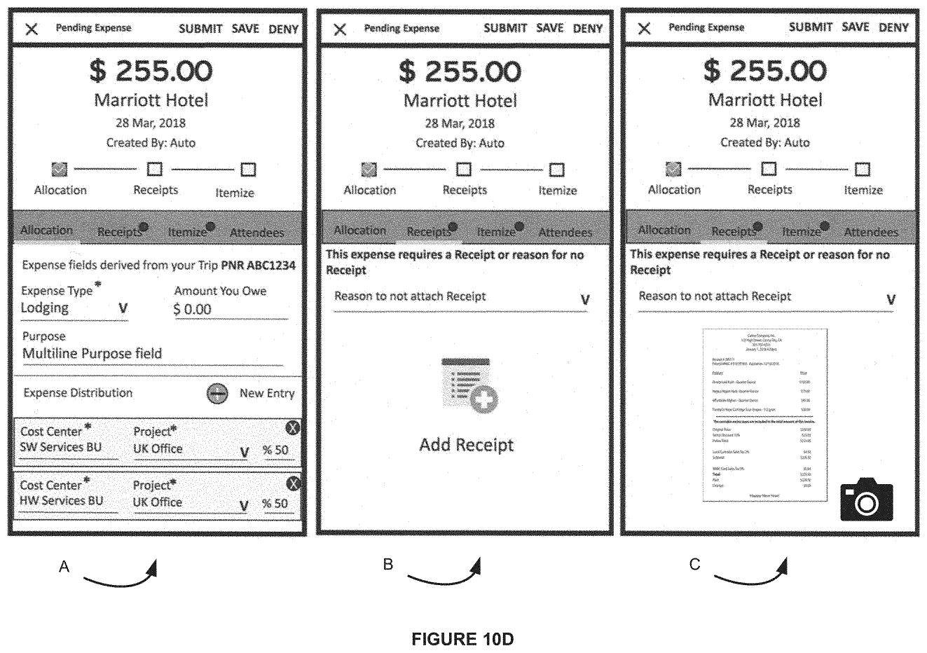

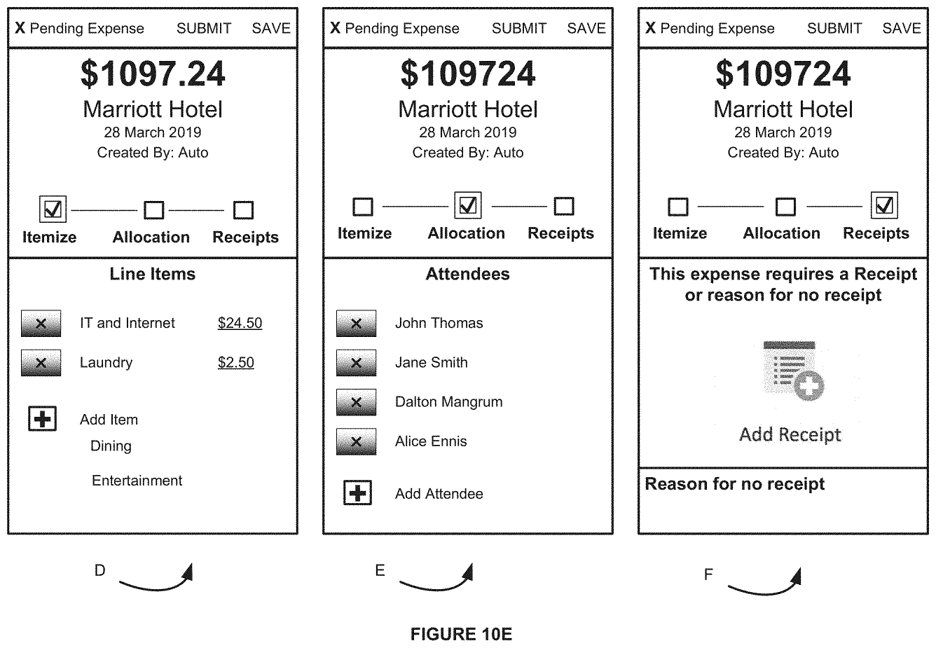

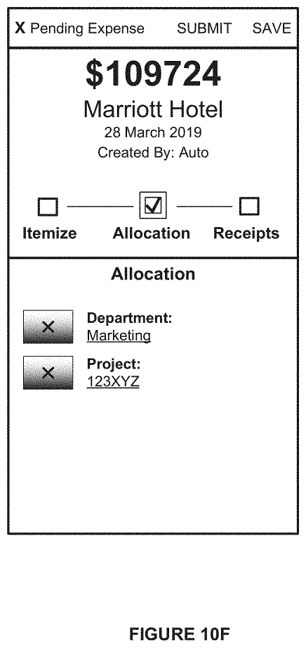

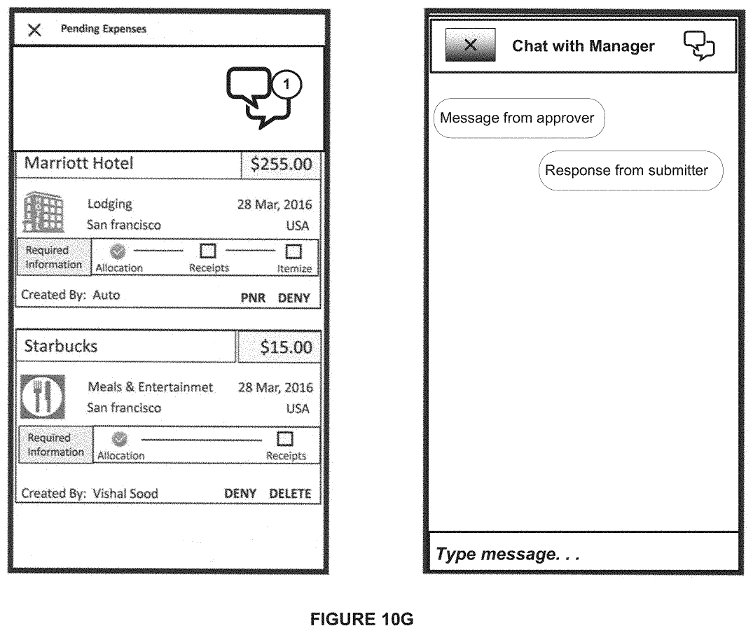

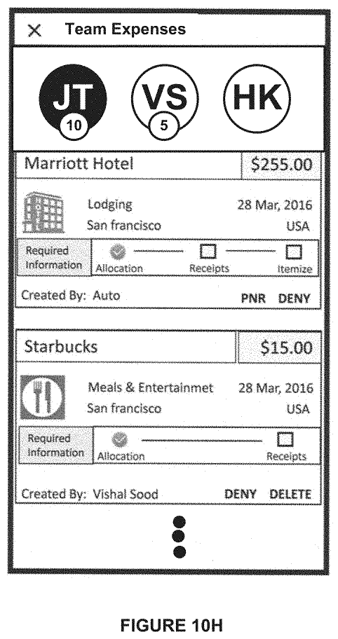

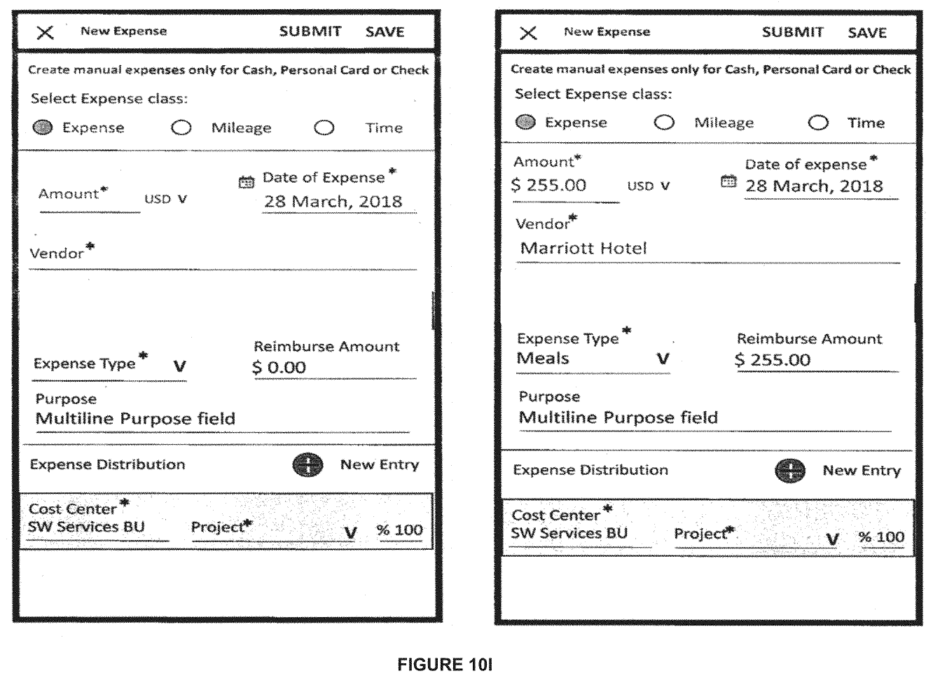

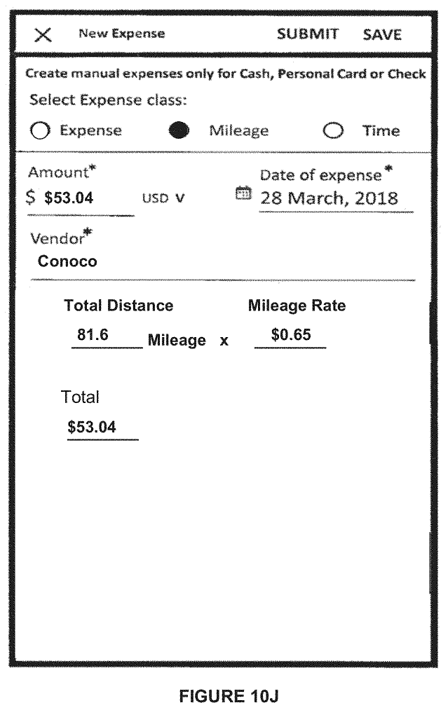

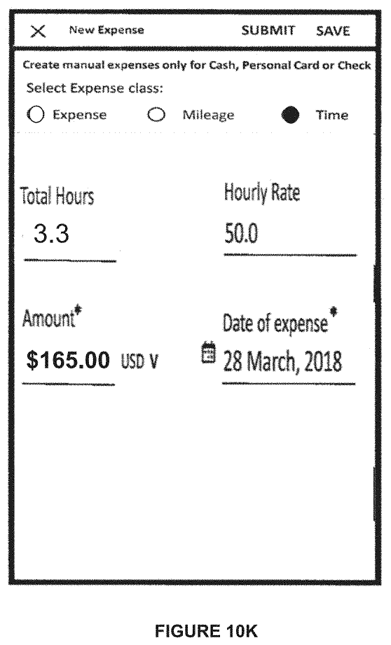

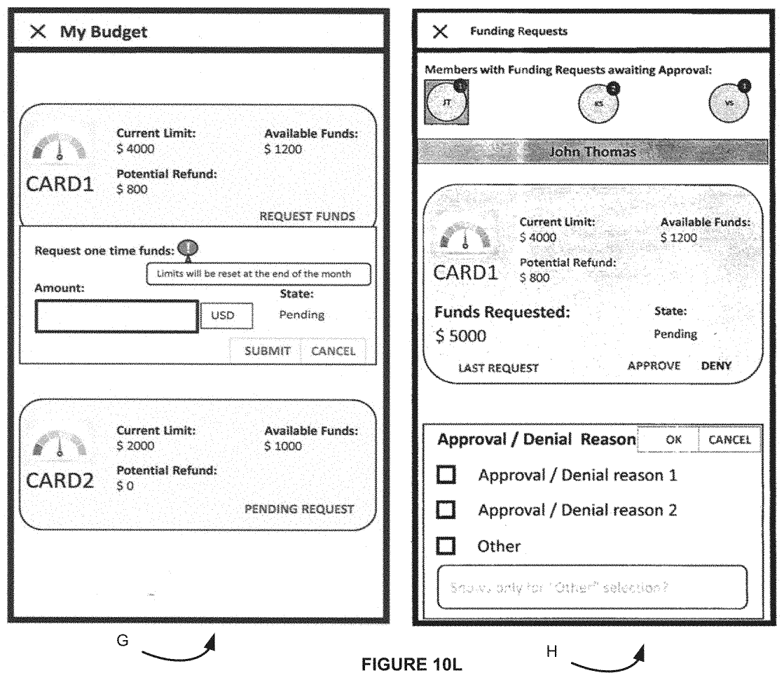

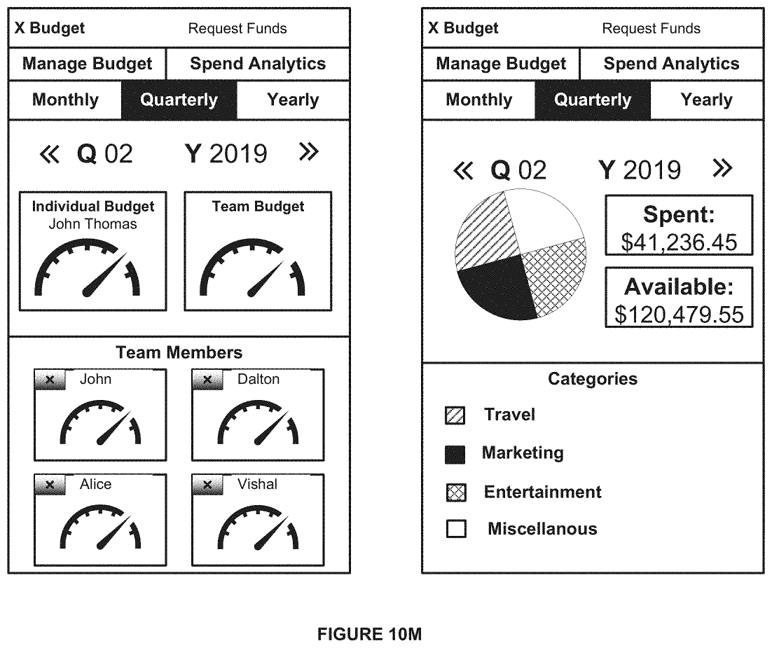

FIG. 10A illustrates an approval workflow 1000. Workflow 1000 may be employed by a transaction management service and/or system to perform the operations described herein. Some or all the steps of workflow 1000 may be implemented in program instructions in the context of the component or components of the application used to manage expenses and budgets to operate as follows.

There are two ways for transactions to enter the approval workflow 1000: auto and manual entry. For example, when the user makes a purchase using the credit card associated with or issued by the transaction management service, the purchase transaction enters the system via the auto stream. When a user manually enters information related to a transaction, the transaction enters the system via the manual entry option.

The transaction management service determines if the transaction requires approval (state 1001). For example, for transactions that are pre-approved, additional approval may not be required, the pre-approved transactions may transition directly to approved (state 1007). In some embodiments, transaction may be pre-approved based on inheritance and/or context.

The transactions that are not pre-approved transition to pending (state 1003). In the pending state, a user may edit or add documentation to the transaction. For example, the user may edit a manual entry where the service has pre-populated fields based on information obtained through other applications. Once the user has finished editing and submits the transaction for approval from the approver (e.g., manager), the transaction transitions to submitted (state 1005). From here, the approver may either approve (state 1007) or deny (state 1009) the transaction.

If the transaction is denied, the approver may request additional information and/or edit the record by indicating why the purchase transaction was denied. For example, the approver may edit a “Notes” field or otherwise note the record with an explanation as to why the transaction was denied. In some embodiments, the transaction management service may include functionality that allows the approver user to message the submitter, which would than trigger a notification in the app for the user to respond. The user may respond by submitting the additional information requested. The transaction would then transition to submitted (state 1005) and proceed to the approver. In other examples, a chat session may be established between the submitter and the approver.

FIG. 10B illustrates an example screen shot of an employee user view of expense items awaiting submission (e.g., state 1003 in FIG. 10A). Expense items awaiting submission may include expense items requiring additional documentation (e.g., receipt(s)) or expense items that are ready for submission, but have not yet been submitted (e.g., user clicks “submit” button). In some examples, only manually created (e.g., “Created By: Vishal Sood”) entries may be deleted, as illustrated “Created By: Auto” does not have the option to “delete.” The “deny” button may cause a pop-up window to appear, with options (e.g., “not my expense,” “fraudulent expense,” or “other”) that the user may select to indicate why the expense item is denied.

FIG. 10C illustrates an example optional rating tool to rate merchants. In some examples, this rating tool may pop-up once the user submits an expense item, allowing the user to rate the merchant/vendor associated with the expense item.

FIG. 10D illustrates example screen shots of an employee view of an expense item in a pending state. Screen shot A illustrates the allocation tab, when the employee user may indicate different cost centers that the expense item should be allocated between. Screen shot B illustrates the receipt tab, allowing the user to add receipt data. The user may click on the add receipt icon to activate a camera on the device. Screen shot C illustrates a screen shot of the user adding a receipt, the user can click the camera icon to capture an image of the receipt.

FIG. 10E illustrates other examples of screen shots of an employee view of an expense item in a pending state. In screen shot D, the user may itemize the expense item. For example, the hotel expense may include charges for Internet (e.g., “$24.50”) and charges for laundry (e.g., “$2.50”). Screen shot E illustrates an example where the user may allocate an expense among multiple employees. For example, several employees may travel together, with one employee paying for some or all of the expenses related to the trip. This allocation tool allows the expense to be debited from each employee's individual budget. The screen shot F illustrates an example of the transaction management application requesting receipt data. The user needs to submit a copy of the receipt (e.g., using camera on device) or provide a reason why the receipt is not available (e.g., receipt lost).

FIG. 10F illustrates other examples of screen shots of an employee view of an expense item in a pending state. The screen shot illustrates another example where the user may allocate an expense. In this example, the user may allocate the expense by department and/or project. In some examples, a manager or approver user may change the allocation data associated with an expense item.

FIG. 10G illustrates an example screen shot where another user (e.g., approver user) initiates a chat with the employee user. For example, the approver user may have a question regarding an expense item, the approver user could send a request/message to the employee. If the user is logged in at the time, the user may accept and start a chat session. In other examples, the employee may respond, and the approver user may receive the response the next time the approver user is logged into their instance of the transaction management application.

FIG. 10H illustrates an example screen shot of a manager view of expense items awaiting her approval (e.g., state 1005 in FIG. 10A; submitted but not approved). For example, employee JT has 10 pending/submitted expense items, employee VS has 5 submitted expense items, and employee HK has zero expense items awaiting approval. The manager user is viewing expense items associated with employee JT as illustrated by the highlighted “JT” icon. The manager user may select one of the other employee users and view their associated submitted expenses. In some examples, only expense items requiring human input/approval will appear in this view. For example, an expense item is submitted without a receipt, the manager user may approve without a receipt. Data associated with manager approval may be stored by the system and used by the context engine and/or machine learning system to adapt and improve approval using context. In other words, context may include machine learning based on previous approvals.

FIG. 10I illustrates an example of an employee manually entering an expense item for the Marriott Hotel.

FIG. 10J illustrates an example of an employee manually entering a mileage expense item. For example, the employee may be reimbursed for travel using his personal vehicle.

FIG. 10K illustrates an example of an employee manually entering a time expense item. For example, the employee may be paid hourly for overtime.

FIG. 10L illustrates example screen shots associated with the budgeting portion of the transaction management application. For example, screen shot G illustrates an employee view of his cards and the available balances associated with the cards. An employee may request additional funds, and a manager may view screen shot H. The manager may approve or deny the funds request. When the manager selects approve/deny, a pop-up window may appear that allows the manager may enter a reason for the approval/denial.

FIG. 10M illustrates a manager view of a budget widget. The screen shots may appear when the manager user clicks the budget widget/icon in the transaction management application.

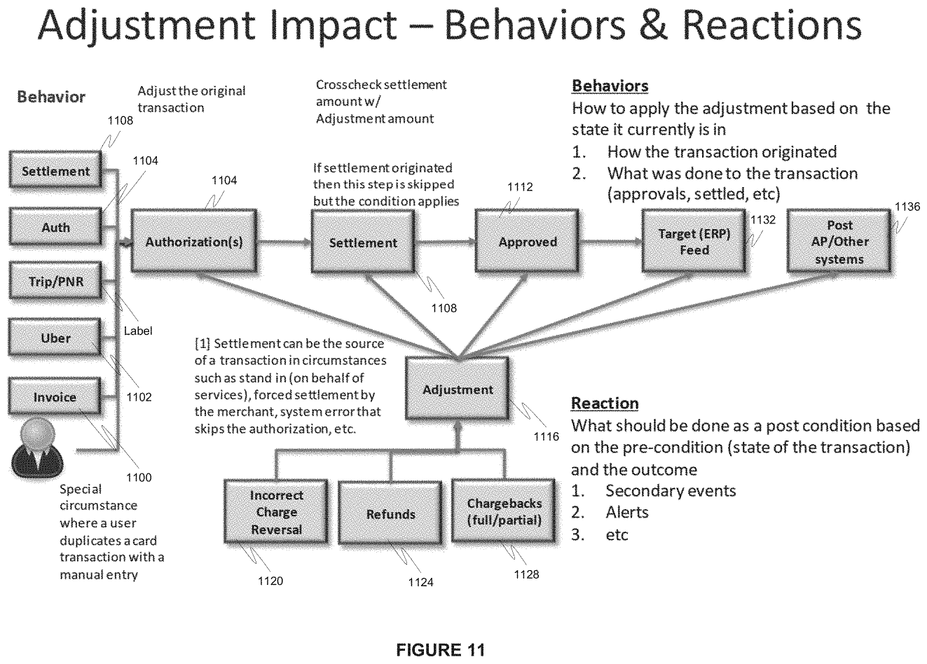

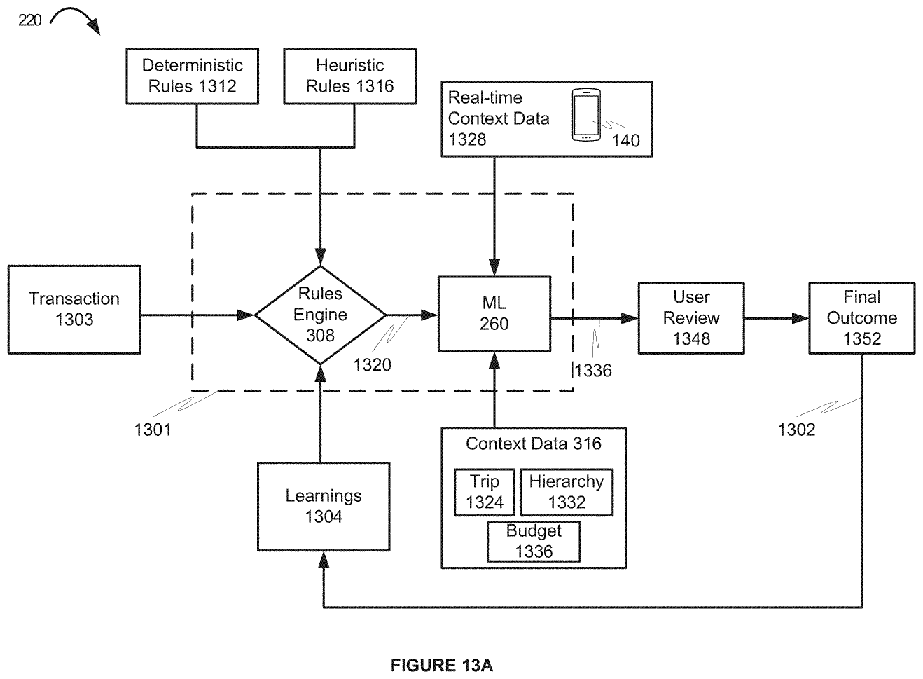

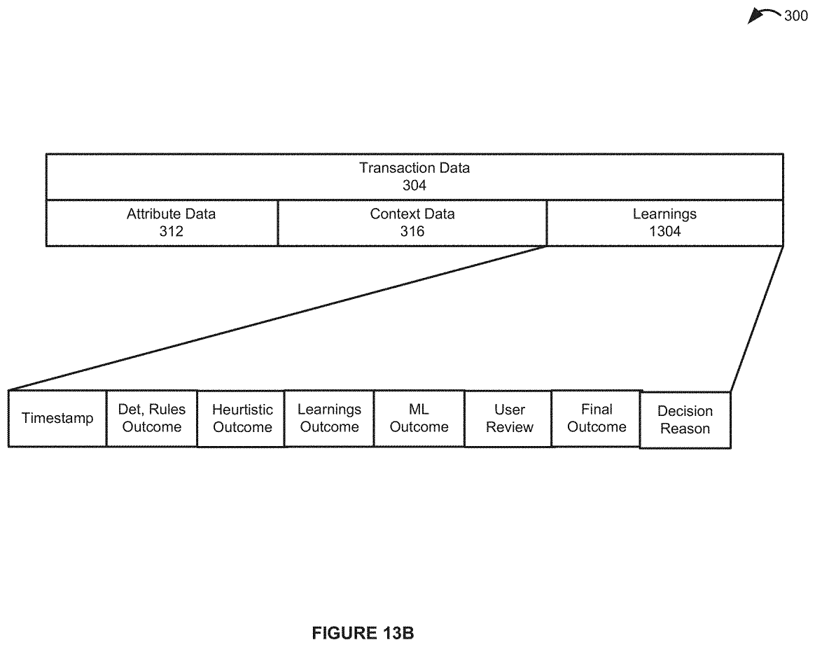

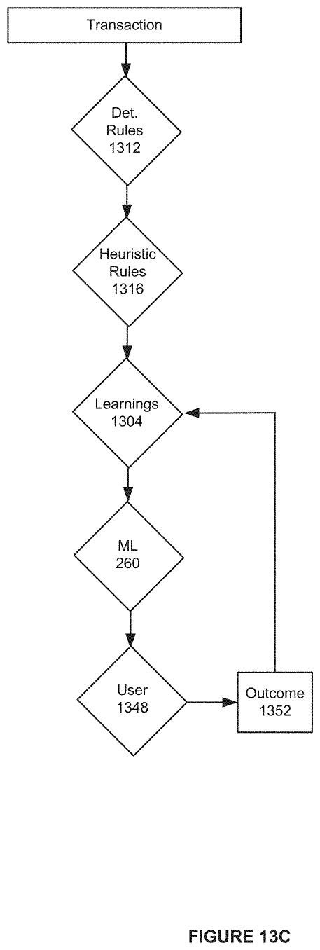

FIG. 11 illustrates an embodiment of a process flow and data structures for adjustments to transactions. A card swipe or other event in which a transaction is charged against a credit or debit card is a transaction and duplicates an amount paid to a vendor by the transaction monitor in settlement 1108 an invoiced item 1100, such as an UBE™ charge 1102, that was previously authorized 1104 and approved 1112 by the transaction monitor 101. Authorization may be performed in real-time. In some examples, the output (e.g., outcome 1352 in FIG. 13) from context engine is approval/denial of the transaction. Authorization includes authorization from credit card issuer (e.g., MasterCard), all the way down to the approver user.

Subsequently, the vendor or the transaction monitor 101 realizes that the card was charged incorrectly, and the vendor adjusts the transaction upward or downward. This reversal event, or adjustment 1116, is also considered to be a transaction having associated transaction data, but it is a modifier on the original transaction and therefore its data structure is linked to the transaction data for the original transaction. Stated differently, it is subordinate to the original transaction data, so the adjustments in the subordinate transaction data modify the transaction data of the original transaction. The adjustment 1116 can be identified by origin of the adjustment, such as incorrect charge reversal 1120, refund 1124, or chargeback (full or partial) 1128. If a customer disputes a whole or a part of a transaction, that is an adjustment to the original transaction, and it can result in a subsequent fund surplus or funds disbursement either in favor of the card holder or in favor of the vendor for the funds. In another example, the user may return the item, this is another transaction (i.e., affects the flow of payment). The notion of a transaction as a series of events until the transaction is final/retired.

The creation of an adjustment event 1116 can cause the transaction monitor 101 to respond with one or more predetermined actions. Examples of such actions include any post condition based on a pre-condition (e.g., state of the transaction), and the outcome, a secondary event or event such as notifying a user or owner of the budget or approving entity, etc. In some embodiments, the adjustment event 1116 can apply the adjustment based on a state that the transaction is currently in (e.g., an origination context of the transaction (how the transaction originated)) or other transaction state (e.g., what was done to the transaction such as approved, settled, pending, authorized, etc.).

The process continues with the adjustment to the transaction data being forwarded as a target feed 1132 to an enterprise resource planning (ERP) system of the corresponding company 130 and/or posting 1136 the adjusted transaction data to an accounts payable or other accounting system.

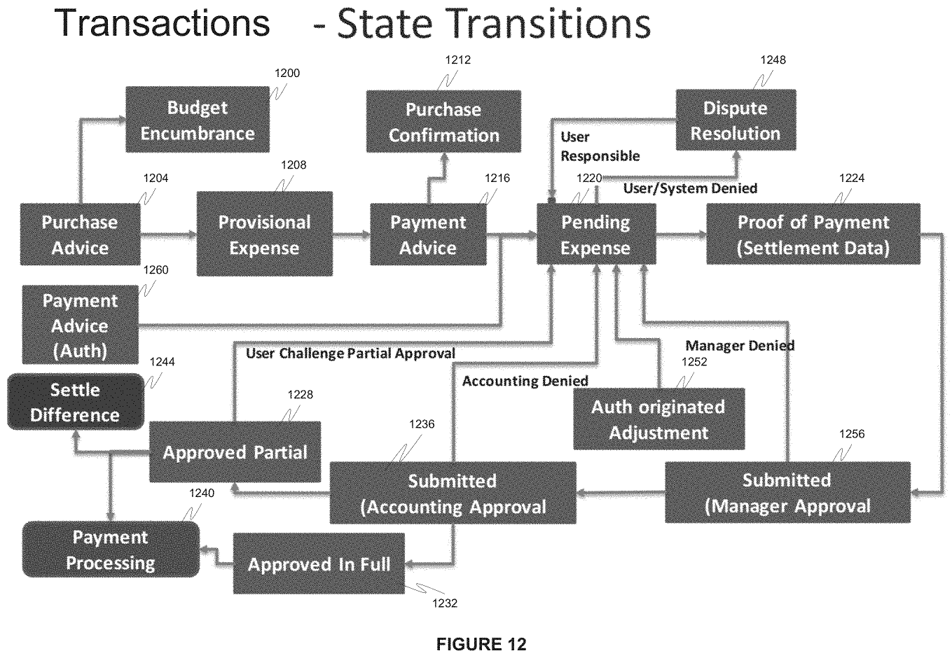

FIG. 12 illustrates a block diagram for transactions state transitions. While FIG. 12 shows a normal sequence of states for a transaction or item, state transitions may not follow the sequence. Each transaction or item has only one state at a time at any given time. The state transitions describe the graduated finality of a transaction from the time of intent to purchase to the time when the statute of limitations expire (e.g., dispute period).

The different states include, but are not limited to, budget encumbrance 1200 in which a budget associated with a transaction is encumbered by an actual or estimated amount associated with the transaction or item; purchase advice 1204 in which a request is received from the user to authorize a transaction or purchase of an item; provisional expense 1208 in which the purchase request is being processed; payment advice 1216 in which a decision is made by the user to proceed with purchase of the transaction or item; purchase confirmation 1212 in which a purchase of the transaction or item is confirmed; pending expense 1220 in which permission to complete the transaction or purchase or pay for an item is in process; proof of payment (settlement data) 1224 in which proof of payment (e.g., payment confirmation or receipt) is received from the vendor; approved partial 1228 in which payment for the transaction or item is approved in part but not in whole; approved in full 1232 in which payment for the transaction or item is approved in full; submitted 1236 in which the transaction or item is submitted to accounting for approval; payment processing 1240 in which the transaction or item is submitted for payment; settle difference 1244 in which the transaction or item is settled with the vendor for partial payment; dispute resolution 1248 in which an amount that was not approved or authorized by a user, manager, or the transaction monitor 101 and allegedly owed for the transaction or item is being determined by a judicial, administrative, mediation, or arbitration proceeding; authorization originated adjustment 1252 in which a manager or other company representative has conditionally approved the transaction or item but the approval is conditioned upon certain adjustment to the terms of purchase; submitted manager approval 1256 indicates that the transaction or item has been submitted for approval by a manager or other representative of the company; and payment advice (authorization) 1260 in which the transaction or item has been authorized for payment by a manager or other company representative. Finality of transaction may be different for different transactions. For example, for a purchase at STARBUCKS®, the approved amount is usually the settled amount. Conversely, at gas stations, a transaction may be authorized for $1.00 and then settled for a different amount (determined after transaction is completed, e.g., gas pump).

Generally, a lifecycle of a transaction or item proceeds as follows: first an intent to purchase receive purchase order from vendor receive invoice from vendor receive authorization from user, manager, or transaction monitor adjustment (if any) by the user, manager, or transaction monitor settlement of the purchase or invoice dispute period expired final resolution or retirement of the liability associated with the transaction or item.

The transaction or item can be approved for payment in whole or part subject to pending payment. An accounting department of the company can approve the transaction in whole or part subject to settlement in a claimed amount. When the transaction is partially approved, the transaction or item may need further consideration (e.g., human input from a user or manager). Accordingly, the transaction or item is sent back to the user to request additional documentation. Upon receipt of the documentation, the transaction or item is resubmitted or reprocessed by the transaction monitor for full payment.

In some embodiments, editing privileges for automatically generated transaction data are restricted by the transaction monitor 101 while editing privileges for manually entered transaction data is different and not as restricted. Automatic entries can NOT be deleted, only available for manual entries

As noted, purchase or payment advice state 1204 or 1260 can be denied for various reasons, including insufficient available corporate funds in a financial institution, insufficient uncommitted funds in the relevant budget, an unreasonable amount of the respective transaction or item, potential fraud associated with the transaction or item, double charge or payment associated with the transaction or item, a return of the transaction or item due to quality issues, and the like.

In some embodiments, the pending expense state 1220 can be due, for instance, to the transaction or item being incomplete or not yet submitted by the user. The transactions or expense items in this state require a user action to be performed. For instance, when the reason for the pending expense state 1220 is incomplete the likely reason is that the user has not completed some aspect of the expense item requirements (an attribute(s) such as purpose, expense type, attendees, allocation, etc. is missing from the corresponding transaction data). When the transaction or item passed through a denial path to reach the pending expense state 1220, it typically means that the transaction or item is pending resolution by the user. When the transaction or item passed through a not submitted path to reach the pending expense state 1220, all actions of the user have been completed but the user has not submitted the expense item (e.g., bit the “submit” button). For example, an expense item may be saved but not yet submitted.

In some embodiments, the submitted (accounting approval) or submitted (manager approval) states 1236 or 1256 mean that the transaction or item has been submitted but the vendor is waiting on settlement, (human) approval, accounting approval (not apparent from the user interface provided by the transaction monitor 101 but the state is backend discernable), or otherwise on approval.

In some embodiments, the budget encumbrance state 1200 occurs when the intent to purchase happens causing the budget to be encumbered for that amount. The transaction monitor 101 estimates this amount using historical cost data for similar or the same transactions or expense items from the relevant company's history or from the history of another company. The estimate can include an additional percentage to account for differences in the transaction or expense item, inflation, tips, and other factors. Stated differently, the estimate can be increased by a percentage that is a function of one or more differences in the historical transactions or items when compared to the current or selected transaction or item, inflation based on a date associated with a timestamp of the historical transaction or item used in the estimate compared to a timestamp of the current or selected transaction or item, a tip (e.g., 15%, 20%, etc.), a currency exchange rate, a fluctuation in a currency exchange rate, or another factor. A purchase order can be used in response to receipt of an intent to purchase, causing funds in the amount of the estimate optionally adjusted by an added percentage to be set aside/allocated. Companies can choose when the encumbrance is set to impact the budget in the form of a budget encumbrance. The purchase order can then become an invoice or enters the payment advice (authorization) state 1260, which state means that the goods are delivered and awaiting payment authorization. When the invoice is approved, there is a finality to the purchase, and the invoice now results in the budget being appropriated to pay for the invoice. The invoice then results in a financial transaction and authorization.

Authorization by a company representative or the transaction monitor 101, or entry into the approved partial or approved in full states 1228 or 1232, can result in a settlement through the transaction or item then entering the settle difference state 1244 or the payment processing state 1240. Adjustments can occur anytime, such as due to disputes, refunds, etc. State transitions enable the transaction or expense item to move from one state to another. Simply put, a budget means that a user is likely to consume the budget amount, and settlement is a result of when the transaction matures and achieves finality.

In some embodiments, the provisional expense state 1208 needs neither proof of payment, nor proof of purchase, until the transaction takes place. If for instance goods are returned, because they were found to be defective, then the expense item has not reached the level of maturity that it is likely to be final. While in this provisional expense state 1208, the transaction or item may or may not mature to movement of funds (e.g., authorization). To what extent funds are moved depends on the context of the authorization based on who the attribute data in the transaction data. The authorization, or entry into the approved partial or approved in full states 1228 or 1232 is a first indicator of the transaction maturing to the state where funds move—up until then, the transaction is still in the provisional expense state 1208. That is to say, the instrument may be allocated, but the vendor and the consumer have not finalized the transaction until the vendor request authorization (e.g., swipes the card). The point of authorization is the first time where the transaction starts to become more concrete.

FIG. 13A is a block diagram that illustrates a context module 220 that includes a decision engine 1301 with a feedback loop 1302. Additionally, the context module 220 comprises a learnings 1304, rules module 248 including a rules engine 1308 to apply deterministic and heuristic rule sets 1312 and 1316 and learnings 1304, and machine learning module 260 to reconcile the various results from application of the deterministic and heuristic rules and mapping of the current or selected transaction data to the learnings 1304 to determine the legitimacy of (approve or deny) a current or selected transaction (e.g., vendor and amount).

For example, a user frequents STARBUCKS® daily and there is no history of the user visiting other coffee shops. The system receives a transaction for STARBUCKS® near the hotel where the user is staying, the context module 320 determines using heuristic rules 1316 that this transaction is approved. Another transaction 1303 comes in for a different coffee shop chain fifteen miles from the hotel, the context module 220 may flag this transaction for further review based on result(s) of the heuristic rules application or learnings mapping because it is a deviation from the user's behavior/past transactions.

Consider the previous example of the user visiting the STARBUCKS® near his hotel, assume an additional fact that the transaction is for $60.00 and the user's previous transactions have all be under $6.00, the context module 220 may in response to application of deterministic or heuristic rules or learnings flag the $60.00 transaction for further review (e.g., user review 1348). The learnings 1304 learns or creates records documenting selected attributes of) the outcomes of other similar transactions to determine whether the current transaction is legitimate; that is, the context module 220 determines the legitimacy of the transaction as well as the legitimacy of the amount. The context module 220 looks for anomalies and fraud by comparing selected fields of the transaction data associated with the selected or current transaction with similar or the same fields of transaction data in the learnings corresponding to a temporally and/or geographically proximate previously approved or disapproved transaction. Additionally, the context module 220 may receive feedback from human input (e.g., user review 1348 and outcome 1352) to adapt the learnings 1304.

Furthermore, the context module 220 may consider corroborating events highlighted by the deterministic or heuristic rules or learnings. For example, the user is at a STARBUCKS®, at a different location, when there is a location near the hotel, but there is no trip leading the user to that location, or if the user chooses to turn on location services on a mobile device 140 and the user is not at the location or near the location, the event may anomalous, but that single event by itself may not constitute fraud, but rather it represents a deviation in behavior based on what the context module 220 has learned about a user. Conversely, if there is a taxi ride to the location prior to the transaction, this corroborating event may lead the context module 220 to approve the STARBUCKS® transaction.

To perform the examples, the rules engine 1308 applies deterministic rules 1312, heuristic rules 1316, and learnings 1304 to a transaction 1303 to determine the probability that the transaction 1303 is legitimate.

For example, in some embodiments, the rules engine 1308 first applies the deterministic rule set 1312 to transaction data associated with a transaction 1303, e.g., the user is or is not at the location associated with the transaction 1303. If the user is in the same location, the deterministic rules 1312 may determine the transaction 1303 should be approved (e.g., the deterministic rule result). If the user is not in the location the deterministic rules 1312 may determine as the deterministic rule result that the transaction 1303 has a greater probability of being illegitimate.

The rules engine 1308 can also apply the heuristic rules 1316 to the transaction 1303. For example, transaction 1303 is on route to the airport, the system can not readily determine the user's current location, but the system determines the user has an upcoming trip from Denver to San Francisco, applying heuristic rules 1316 the context module 220 can determine (as the heuristic rule result) that the transaction 1303 is probably legitimate. However, if the transaction was for a purchase in Florida, the context module 220 using either or both deterministic rules 1312 and/or heuristic rules 1316, as the deterministic or heuristic rule result, may decline the transaction.

The learnings 1304 can include any type of transaction data 304 and/or learnings (e.g., timestamps, deterministic rule outcomes, heuristic rules outcomes, learnings outcome, ML outcome, user review result or changes, and/or final outcome (e.g., approve or deny or requires further review due to one or more anomalies) associated with a transaction or item as well as evidence of other events related to a transaction to change/adapt the behavior of the system.

The deterministic rules 1312 are rules that, given a particular input, will necessarily produce the same or common output. Stated differently, the deterministic rules are black and white rules and may applied before the heuristic rules (e.g., a user is at a location or she is not). For example, if Location Services are turned on, the rules engine determines that a user is at the location. If Location Services are not turned on, the rules engine concludes that the user is not at the location. A transaction 1303 may be approved or denied based on the location information.

The heuristic rules 1316 are rules may allow the system to approve/deny anomalous behavior identified by the deterministic or heuristic rules 1312. The heuristic rules 1316 look for context, corroborating events, past behavior, etc. Based on the context, the heuristic rules 1316 may determine as the heuristic rule result that a transaction 1303 is probably legitimate or illegitimate.

The heuristic rules 1316 may look for corroborating events (e.g., UBER® to location of current transaction) such that the suspected anomalous event that taken individually may be considered a deviation, but when considered with a corroborating event (e.g., a chain of events) may be approved. In the UBER® example, the heuristic rules 1316 allows context module 220 to use a corroborating event that the user took an UBER® to that location to determine legitimacy of a transaction 1303. Because there is a corroborating event, though the event by itself is a deviation, there are prior events establishing the context that legitimizes the new event, so there's a chain of command between events. Heuristic rules 1316 can learn and be specific to individual behavior and allow the context module 220 to extend the legitimacy of the interaction from what the user has done to what she is doing to what she is likely to do.

In another example, the heuristic rules 1316 may consider future events to approve a current transaction. The transaction monitor 101 receives an authorization request from the STARBUCKS® in Concourse B at Denver International Airport. In response, the context module 220 can determine that there is an upcoming flight to Alaska (e.g., future event) and therefore, using heuristic rules 1316, determines that the transaction at STARBUCKS® is legitimate.

The rules engine 1308 applies the deterministic and heuristic rules to produce output (e.g., probability a transaction is legitimate or not legitimate or warrants further review due to anomalous behavior involved in the transaction). The rules 1312 and 1316 may be input into the transaction monitor 101 and/or context module 220 beforehand. The rules 1312 and 1316 may be weighted. For example, some rules may be absolute, while others may be flexible. The rules may be weighted relative to their category (e.g., deterministic or heuristic) or as a group (deterministic and heuristic considered as a group of rules). Alternatively, or additionally, the rules may be weighted regardless of category; that is, a deterministic rule may have a higher weighting than a heuristic rule or vice versa, a deterministic rule may have a higher weighting than a learnings transaction record or vice versa, or a heuristic rule may have a higher rating than a learnings transaction record or vice versa. This output may be further processed using the learnings 1304, which may change the output. The output 1320 is provided to the machine learnings module 260. The output 1320 can be in any form that indicates a set of rule-based observations about transaction 1303. For example, the output 1320 can identify one or more applicable rules and a respective observation or conclusion for each rule. The output 1320 can include one or more learnings 1304.

Each of the rules (e.g., deterministic, heuristic and learnings) may carry or be attributed a weight and the weight of the rules assigned or determine by the system influence the decisions rendered. For example, if a transaction at a STARBUCKS® is approved by the system but ultimately denied by the manager, the first instance of denial may not create a learnings/pattern. However, however similar transactions denied over a period of time may cause the learnings 1304 to deny the transaction that the rules 1312/1316 approved. The learnings become a system generated rule that says that a transaction at that particular STARBUCKS® location must be denied or transaction at STARBUCKS® by a particular employee should be denied.

Deterministic rules 1312 may be absolute—transactions at OFAC countries are prohibited. This rule must be applied with a 100% reliability and is weighted such that it cannot be countermanded.

In another example, STARBUCKS® transactions are denied at a location unless there is a corroborating event, such as a corresponding convention that was approved and thus the convention legitimizes the STARBUCKS® transaction at that location which would otherwise have been denied.

In one embodiment, the output comprises a concatenated data string comprising the transaction record for the current or selected transaction, a link or other identity of one or more deterministic rules that apply and a respective result for each rule, a link or other identity of one or more heuristic rules that apply and a respective result for each rule, and one or more timestamps associated with the transaction, rule application(s), etc.

The machine learning module, based on the learnings, performs a specific task without using explicit instructions, relying on patterns and inference based on mapping the current or selected transaction to the learnings. The machine learning module through the learnings 1304 builds one or more patterns based on sample data, known as “training data” to make predictions or decisions without being explicitly programmed to perform the task. As will be appreciated, the machine learning module creates learnings 1304 initially by fitting on a training dataset, that is a set of examples used to fit the parameters (e.g., weights of connections between neurons in artificial neural networks) of the model. The model (e.g., a neural net or a naïve Bayes classifier) is trained on the training dataset using a supervised learning method (e.g., gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable pattern selection and parameter estimation.

The machine learning module can base the learnings 1304 on supervised, semi-supervised, and/or unsupervised learning. In supervised learning, the algorithm builds a mathematical model from a set of data that contains both the inputs and the desired outputs. For example, if the task were determining whether a transaction data contained a certain object, the training data for a supervised learning algorithm could include transaction data with and without that object (the input), and each set of transaction data would have a label (the output) designating whether it contained the object. In special cases, the input may be only partially available, or restricted to special feedback. Classification algorithms and regression algorithms are examples of supervised learning. Classification algorithms are used when the outputs are restricted to a limited set of values. Regression algorithms are named for their continuous outputs, meaning they may have any value within a range. Examples of a continuous value are the temperature, length, or price of an object. Semi-supervised learning algorithms develop mathematical models from incomplete training data, where a portion of the sample input doesn't have labels. In unsupervised learning, the algorithm builds a mathematical model from a set of data which contains only inputs and no desired output labels. Unsupervised learning algorithms are used to find structure in the data, like grouping or clustering of data points. Unsupervised learning can discover patterns in the data, and can group the inputs into categories.

In some embodiments, the machine learning module uses the learnings 1304 to perform anomaly detection, or outlier detection, to identify rare items, events or observations which may be approved/denied by the system but always overridden by the approver in user review 1348. The system can use learnings 1304 to adjust the outcome from rules 1312/1316 to match the outcome 1352 from user review 1348. The system approved, but the approver denied or vice versa. In another example, the transaction monitor 101 may deny a transaction, and then receive a data record for a similar transaction (in close time proximity) to the declined transaction on the user's personal instrument, this may also inform learnings 1304 to approve future similar transactions based on approval on the transaction on the user's personal instrument. Similarity of transactions may be based on matching fields in learnings 1304, a threshold of matching fields indicates the learnings 1304 should apply the outcome 1352 of the similar record to inform the outcome of this transaction.

In one embodiment, the learnings comprise a concatenated data string comprising a transaction record for a previously approved or disapproved transaction, a link or other identity of one or more deterministic rules that applied to the transaction and a respective result for each rule, a link or other identity of one or more heuristic rules that applied to the transaction and a respective result for each rule, a link or other identity of one or more learnings records that applied and a respective result for each record, a recommended result by the machine learning module based on the deterministic and heuristic rules and learnings records, and a change made to the recommended result by a human observer, and one or more timestamps associated with the transaction, rule application(s), human observer change, etc. The timestamp can be used to filter out learnings records that are temporally not proximate to the current or selected transaction.

Typically, the anomalous items represent an issue such as fraud by a user or errors in a transaction. The module can use any of: unsupervised anomaly detection techniques that detect anomalies in an unlabeled test data set under the assumption that the majority of the instances in the data set are normal, by looking for instances that seem to fit least to the remainder of the data set; supervised anomaly detection techniques that require a data set that has been labeled as “normal” and “abnormal” and involves training a classifier (the key difference to many other statistical classification problems is the inherent unbalanced nature of outlier detection); and/or semi-supervised anomaly detection techniques that construct a model representing normal behavior from a given normal training data set, and then test the likelihood of a test instance to be generated by the model.

The machine learning module 260 receives the output 1320 from the rule application by the rules engine and transaction data or other data associated with the current or selected transaction (e.g., context data 316 and real-time context data 1328). For example, context data 316 may include trip data 1324, company hierarchy data 1332, and budget data 1336. Real-time context data 1328 may be retrieved from device 140, and include information, such as current geographic location and user presence information, to provide further output 1336. Organizational hierarchy 1332 may include data regarding an employee's work location, domicile, supervisor, work schedule, etc. The context module 220 may consider this organizational hierarchy data 1332 as context data. For example, an employee may be located in Denver, and reports to a supervisor located in Seattle, therefore, the employee may make frequent trips to Seattle to report to his supervisor. This organizational hierarchy data may be considered by the context module 220.

Trip data 1324 may be considered as context data by context module 220. For example, if a trip is approved, that approval may be inherited by other transaction related to the trip (e.g., transportation and lodging).

Budget data 1336 may be considered by context module 220. For example, if a user has exceeded his daily budget, transactions may be denied until the budget is reset the next day. In another example, if the employee has used his entire budget for the time period (e.g., monthly, quarterly, yearly, etc.) all transactions (even legitimate) ones may be denied until the employee receives additional funds.

Geographic location data 1328 may also be considered as context data by context module 220. For example, the employee may have a mobile device with Location Services enabled. Therefore, the mobile device may be used to determine a current location of the employee. If the current location of the employee matches or is in close proximity of location data associated with a transaction, that may form context approval for the transaction. Conversely, if the employee's current location is in another state from the location associated with a transaction, that transaction may be denied and flagged as fraudulent.

Machine learning module 260 may apply constraints to learnings 1304 to prevent inappropriate outcomes. Additionally, machine learning module 260 may be used to resolve conflicts, such as conflicts between rules 1312 and 1316.

The output 1336 can pass through the rules engine output without change, modify the rules engine output to include a fraud alert or alert of other anomalous behavior, a recommendation on whether or not the associated transaction 1303 should be approved, modified, or denied, or other observation related to the user (who is a known party to the transaction monitor 101) that should be brought to the attention of management of the company.

The system may be in an observer mode (e.g., observe outcomes but make no adjustments) or influencer mode (e.g., make adjustments based on learnings 1304).

Machine learning module 260 output is reviewed by a user, such as a manager, accounting department employee, or other higher level or responsible company representative, and the output is further modified if appropriate. The user himself can further review 1348 and accept, modify, or refuse to accept the output and make appropriate modifications. These reviews produce an outcome 1352, which is returned back to the learnings 1304 as part of the learnings 1304. The outcome 1352 can include one or more attributes of the learnings, which attribute can be derived from the attributes in the outputs 1320 and 1336.

The outcome 1352 from the machine learning module for the selected or current transaction can include a concatenated data string comprising the transaction record for the current or selected transaction, other data associated with the transaction, a link or other identity of one or more deterministic rules that apply and a respective result for each rule, a link or other identity of one or more heuristic rules that apply and a respective result for each rule, a link or other identity of one or more learnings records that apply and a respective result for each record, and one or more timestamps associated with the transaction, rule application(s), etc.

Based on the outcome 1352 and the modifications to the outcome 1352 relative to the outputs 1320 and 1336, the learnings 1304 can change the outcome based on the deterministic rules 1312 and/or the heuristic rules 1316. Therefore, while the deterministic rules 1312 and heuristic rules 1316 may be inputted by a user, the learnings 1304 may be “rules” determined by the system and used to adapt the system to be in line with decisions made by the human user in user review 1348. In other words, learnings 1304 may change the behavior of the system based on rules 1312/1316. If the human user affirms the system's approval/denial decision, the learnings 1304 can determine the system's behavior is good (e.g., inline with human user). On the other hand, learnings 1304 determines that its approval/denial decisions are consistently being overturned by human review 1348, the system can determine the rules 1312/1316 result in “bad” behavior.

The learnings 1304 may process this approval to create a new context (e.g., approver(s) consistently approves these transactions). There is no other context except consistency of approvals by different people, so there is no probability of collusion between the perpetrator and the approver, since multiple people are approving this type of transaction that seems to be normally a deviation from the norm—therefore that transaction is now legitimate.

Metadata about the environment that is either preconfigured through known quantities or acquired as the transaction evolves and those contexts—like, if a user travels to San Francisco monthly, but the travel is not in the job description, it is just behavior the user has exhibited. Moreover, when in San Francisco, the user always stays at the WESTIN®. Now that behavior is established so it becomes a second business home for user. Although it may not be listed as such in any organizational charts (hierarchy data 1332) that the user has two locations, but a behavior is getting established. In other words, approval generating context, and then boundaries of the transaction. An airline, it defines roundtrips, hotel stays, number of days, so a context is now starting to get established with the trip and then other transactions can now relate to say this transaction defines the boundaries but other transactions can take place at these locations. So, a physical card swipe in Denver, at the same time when a trip has occurred and there's a card swipe in San Francisco, now one of the swipes represents a deviation on that event that is outside the norms of what should have happened.

Context module 220 may be applied to a transaction at any/all stages of the transaction lifecycle. For example, a transaction 1303 may be approved at the card swipe, but later denied by ML 260. Output 1336 may be a recommendation for approver to deny the transaction, at which point it becomes the employee's responsibility.

FIG. 13B data structure of transaction data, that includes learnings 1304. The learnings may include the fields: timestamp, applicable deterministic rules 1312 and associated outcome, applicable heuristic rules 1316 and associated outcome, applicable learnings 1304 and associated outcome, machine learning 260 outcome for the corresponding transaction, user review result or changes 1348 and reviewer identity (e.g., user or manager), final outcome 1352, and decision reason. Learnings 1304 may use these fields or other fields to identify similar transactions that should be considered using learnings 1304.

FIG. 13C is a flowchart illustrating the operation of the context module 220. First, context module 220 considers the transaction under deterministic rules 1312, which may approve or decline the transaction 1303. The outcome based on the deterministic rules 1312 is reconsidered based on the heuristic rules 1316, which may adjust the outcome (more or less likely that transaction 1303 is legitimate). Next, if there are learnings 1304 (similar transactions) outcome may be further adjusted. Next, the context module 220 applies ML 260, which may be constraints on learnings 1304. Next, the outcome is considered by human review 1348. For example, the context module 220 outcome up to this point is denial, but a manger overrides denial decision and approves the transaction 1348 in user review 1348, system/learnings 1304 notes outcome 1352 using feedback loop 1302 to create a learning 1304 (individual, similar transactions, etc.). Learnings 1304 can transform outcomes 1352 into a pattern used to override rules 1312/1316. Learnings 1304 may inform system to change/adjust rules 1312/1316.

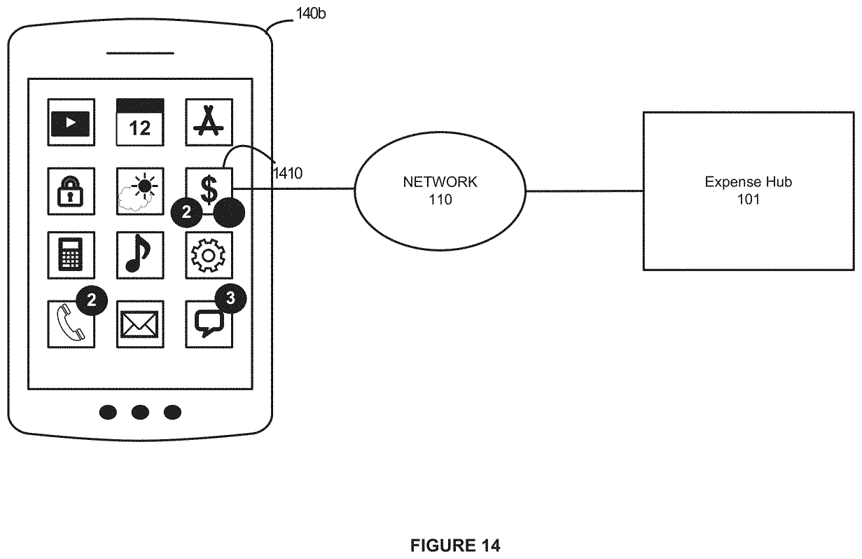

FIG. 14 illustrates an example of a transaction management application represented by application launch icon 1410, running on the user device 140b. The transaction management application communicates with transaction monitor 101 over network 1430. In some embodiments network 1430 comprises a wireless or cellular network.

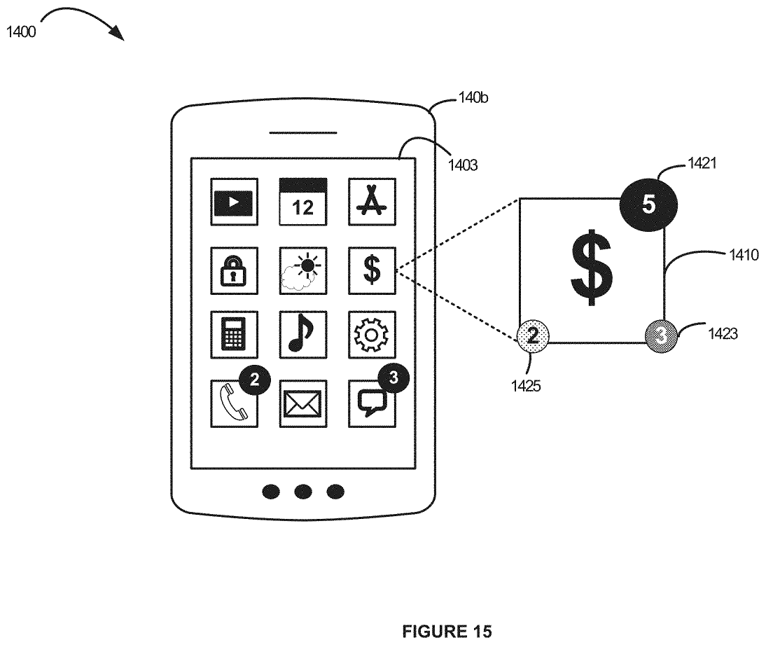

FIG. 15 illustrates an example of the application launch icon 1410 displaying notifications for the transaction management application (app) using multiple badges 1421, 1423, and 1425. Example 1400 includes device 140b, which includes a display that displays home screen 1403. Displayed on home screen 1403 are various launch icons associated with various apps.

One of the apps is transaction management app associated with the application launch icon 1410, with the “$” symbol. Application launch icon 1410 has badges 1421, 1423, and 1425 associated with notifications for the user. In some embodiments, badge 1421 comprises the total number of notifications from the app and badges 1423 and 1425 are notifications from different channels in the app. In other words, there are 5 total notifications; 3 from the channel associated with badge 1423 and 2 from the channel associated with badge 1425. Badge 1423 may be associated with reminders and indicates there are 2 reminders for the user.

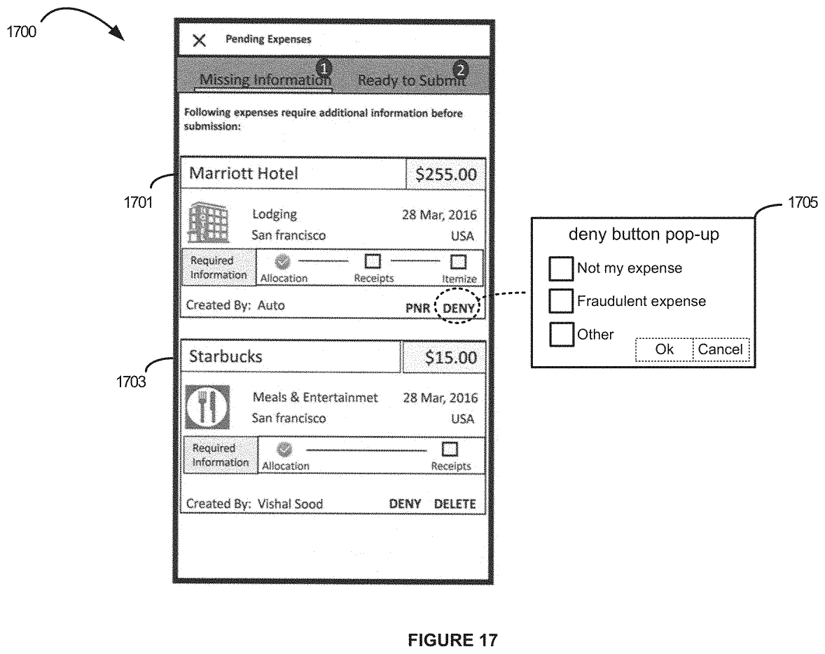

A reminder notification may be a reminder to book a hotel for an upcoming trip where the flight is already booked. A reminder notification may be a reminder to book a ride to the airport for an upcoming flight. To determine when to remind the user to arrange for transportation, the service may determine a flight time, an average travel time to the airport, an average time to complete airport security, available transportation, and/or other factors related to determining a travel time. In determining travel time, the service may access real-time traffic data, route information, available transportation (i.e. the closest taxi, average wait time for an LIBER® or LYFT®). In some embodiments, the various badges may be different colors, and may be settable by the user. Additionally, the user may be able to set which channels to receive notifications for. FIG. 17A is an example embodiment and it is understood that each app launcher icon may have more or fewer badges than as shown.

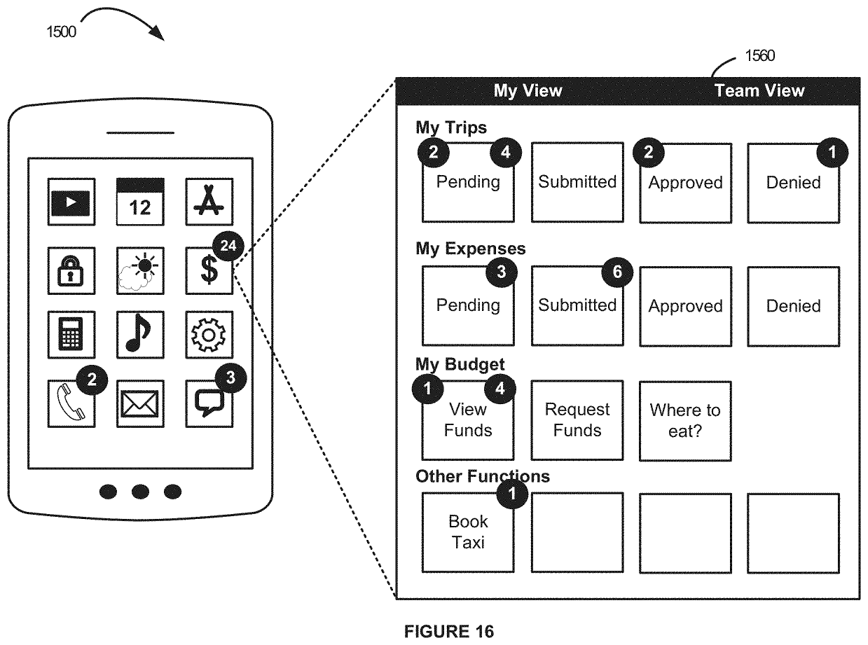

FIG. 16 illustrates an example 1500 of the initial screen 1560 displayed when the transaction management app is launched. The user can select to either view their personal view “My View,” or view data for the team “Team View.”

In this example, the user is in “My View.” The initial screen displays multiple widgets associated with the transaction management service. There are several main categories: “My Trips,” “My Expenses,” “My Budget,” and “Other Functions.” Each category has widgets that correspond to various functions that may be performed in each category. For example, under “My Expenses,” the user may select the “Pending” widget to view all pending transactions. In some embodiments, the user may select “Pending” to edit entries. For instance, a user may edit an entry by adding a photo of the corresponding receipt. Additionally, as shown, some widgets have multiple badges, which may correspond to different notifications associated with each widget.

In another example, a user may select the “Denied” widget under the “My Trips” category to view and transactions that were denied. In some embodiments, the user may be requested to submit additional documentation and re-submit the transaction for approval.

In yet another example, a user may view data associated with the user's budget. Additionally, under the “Team View” tab, the budget data displayed may be cumulative for the whole team or department.

FIG. 17 illustrates example 1700 of a user interacting with the transaction management application to enter purchase transactions. Example 1700 includes two entries 1701 and 1703. Entry 1701 is an example of an automatic entry, as indicated by “Created By: Auto.” In some embodiments, automatic entries are generated when a certain payment method is used. For example, a user may associate a credit card with the service. In other examples, the service may issue the credit card.

In some examples, when a record for a purchase transaction is automatically added, the user may be given the option to “DENY” the transaction. For example, if the transaction is fraudulent. The user may select “DENY,” and pop-up window 1705 is displayed. The user may select one of the reasons for denying the transaction. This allows the transaction to be denied in real-time at the transaction originator (e.g. MARRIOT® hotel).

Entry 1703 is an example of a manual entry, as indicated by “Created By: Vishal Sood.” For example, if the user pays with cash or another form of payment not associated with the service, the user may be required to manually enter such transactions.

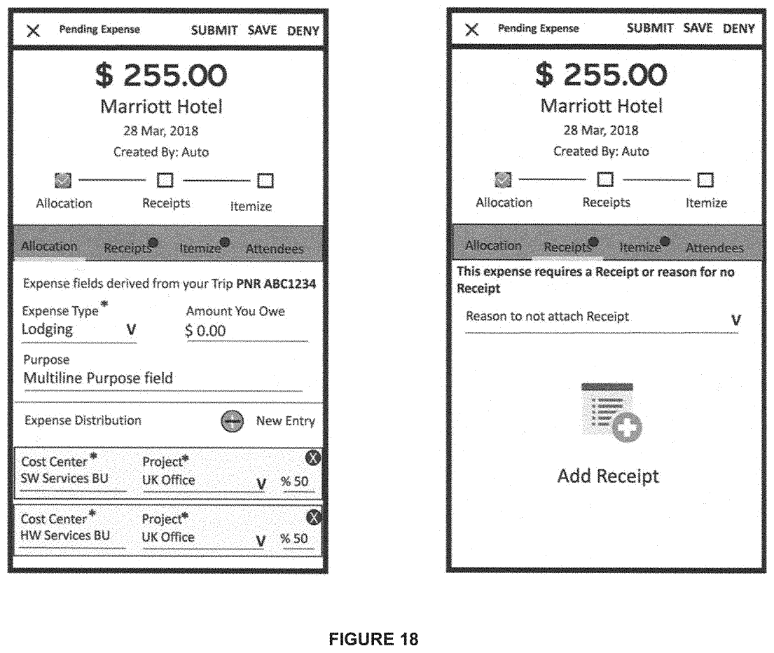

FIG. 18 illustrates an example where the user may edit a purchase transaction entry. For example, the user may edit the various fields, type, amount, purpose, etc. Additionally, the user may edit or set an allocation for the expense transaction. For example, if the cost should be split 50/50 between two clients and/or expense accounts. Moreover, the user may add a photo of the receipt, by selecting “Receipts.”

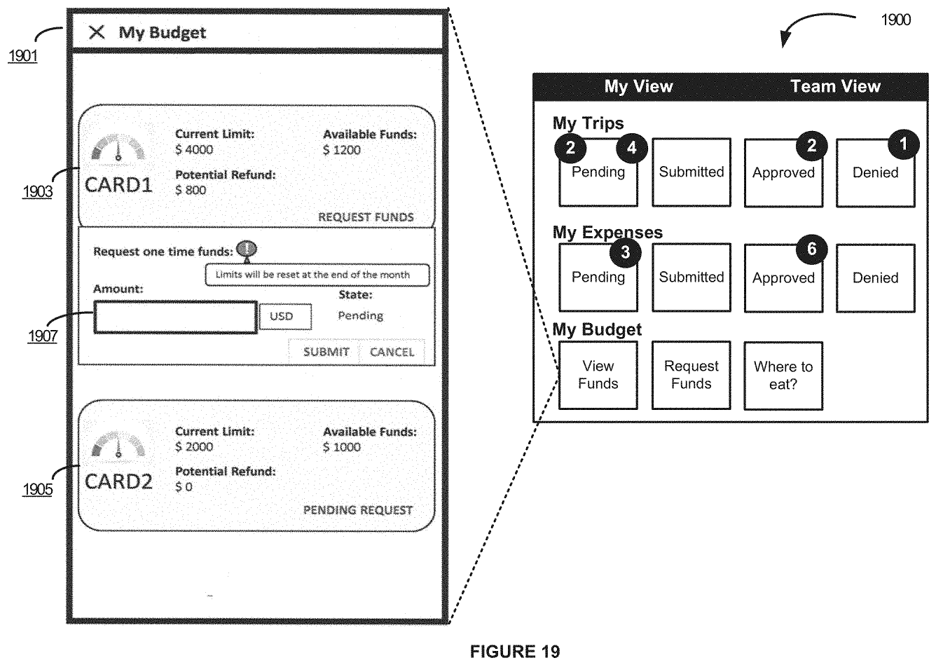

FIG. 19 illustrates an example 1900 of the transaction management application. From the initial screen, the user may select “View Funds” from the “My Budget” category. The “My Budget” screen 1901 may then be displayed. Within My Budget 1901, there are three sections illustrated 1903, 1905, and 1907. Sections 1903 and 1905 are associated with Card 1 and Card 2, respectively. Sections 1903 and 1905 give a visual representation textual information of the budget remaining on each card. In section 1907, a user may request additional funds.

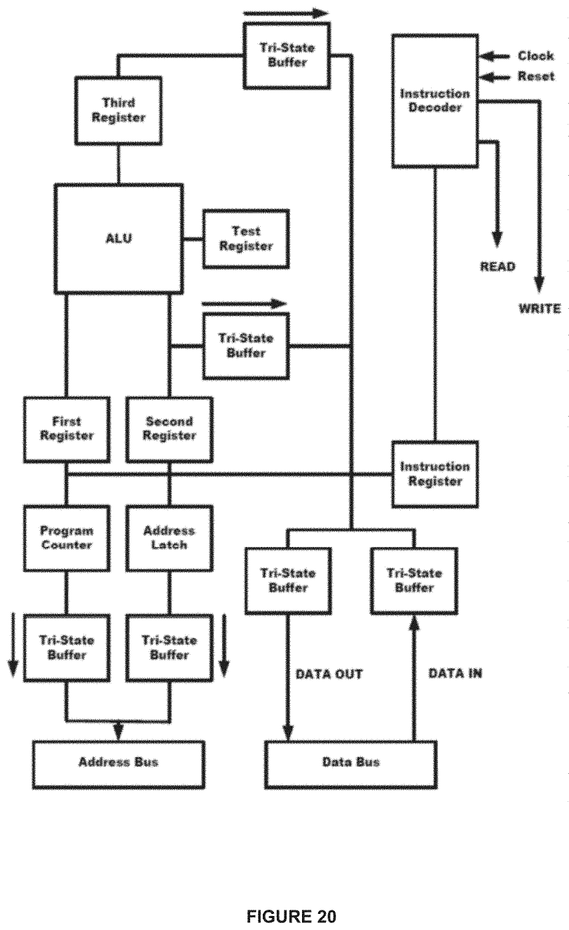

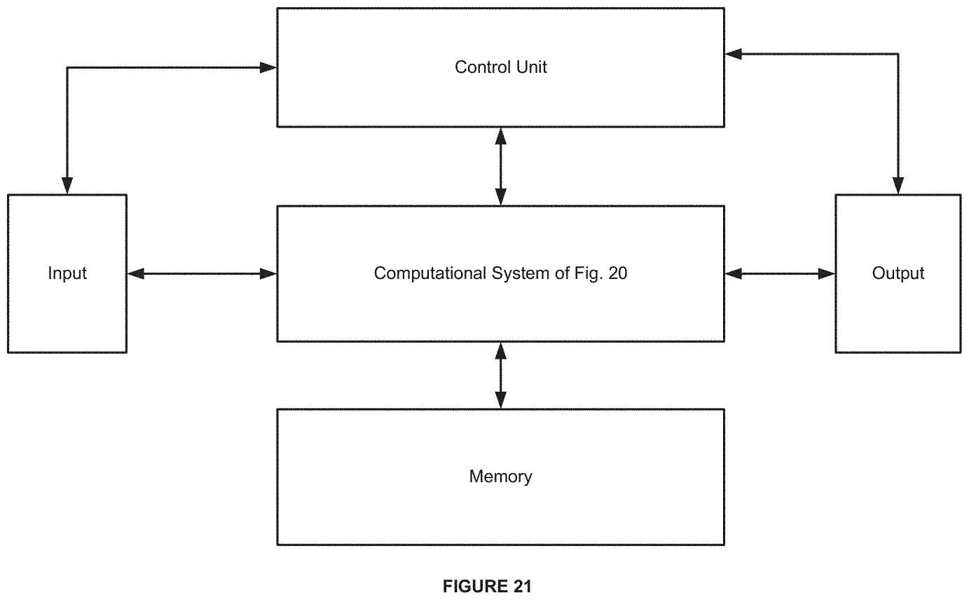

With reference to FIGS. 20-21, the transaction monitor can perform any of the operations or functions set forth above using an arithmetic logic unit (“ALU”), which performs mathematical, arithmetic, and/or logic in response the execution of one or more instructions operations, such as addition, subtraction, multiplication, and division, machine instructions, an address bus (that sends an address to memory), a data bus (that can send data to memory or receive data from memory), a read and write line to tell the memory whether to set or get the addressed location, a clock line that enables a clock pulse to sequence the processor, and a reset line that resets the program counter to zero or another value and restarts execution. The arithmetic logic unit can be a floating-point processor that performs operations on floating point numbers. The arithmetic logic unit can, for instance, perform logical operations (such as AND, OR NOT, XOR, NOR, NAND, etc.), bit shifting operations (e.g., shifting positions of bits by a determined number of places to the right or left), and/or arithmetic (e.g., bit addition and subtraction) operations. As shown in FIG. 21, the ALU can work in conjunction with (and under the control of) a control unit (“CU”) that extracts instructions from memory and decodes and executes them. The transaction monitor 101 can further include first, second, and third registers that are typically configured from flip-flops, an address latch, a program counter (which can increment by “1” and reset to “0”), a test register to hold values from comparisons performed in the arithmetic logic unit, plural tri-state buffers to pass a “1” or “0” or disconnect its output (thereby allowing multiple outputs to connect to a wire but only one of them to actually drive a “1” or “0” into the line), and an instruction register and decoder to control other components. Control lines, in the transaction monitor, from the instruction decoder can: command the first register to latch the value currently on the data bus, command the second register to latch the value currently on the data bus, command the third register to latch the value currently output by the ALU, command the program counter register to latch the value currently on the data bus, command the address register to latch the value currently on the data bus, command the instruction register to latch the value currently on the data bus, command the program counter to increment, command the program counter to reset to zero, activate any of the plural tri-state buffers (plural separate lines), command the ALU what operation to perform, command the test register to latch the ALU's test bits, activate the read line, and activate the write line. Bits from the test register and clock line as well as the bits from the instruction register come into the instruction decoder. Hardware similar or identical to that of FIG. 20 can be not only in the transaction monitor 101 but also in the database 120 or computational systems of the financial institution 160, vendor 150, user 140, or companies 130. The ALU, for example, can execute any of the modules in the transaction monitor 101, including the context module 220, attribute module 224, transaction module 236, employee module 228, vendor module 244, rules module 248, application module 252, budget module 256, and machine learning module 260.

Embodiments include a system comprising a communications interface that enables communications with a communication device of a selected user; an arithmetic logic unit and control unit coupled to the communications interface, wherein the arithmetic logic unit performs one or more mathematical operations and compares selected variables and the control unit executes instructions; a register to hold a value from a comparison of selected variables performed by the arithmetic logic unit; a computer-readable storage memory comprising transaction data and instructions that are executable by the control unit; an instruction decoder to provide read and write commands to the computer-readable storage memory; an address bus to provide a location address to the computer-readable storage memory for a read or write operation; a data bus, coupled with the arithmetic logic unit, register, control unit, computer-readable storage memory, instructions decoder and address bus, to provide or access data for a write or read operation to or from the computer-readable storage memory; wherein the arithmetic logic unit and/or control unit, in response to the control unit executing the instructions: receives transaction data for approval, wherein the transaction data includes attribute data; derives context information associated with the transaction data from at least one of a financial institution associated with the transaction data, a vendor associated with the transaction data, a user associated with the transaction data, and/or an employer associated with the user; determines whether to approve the transaction data based on at least one of the attribute data and the derived context information; and in response to the transaction data being pre-approved, updates a record associated with the transaction data to indicate the approval.

Embodiments include a method of providing transaction management comprising the steps of: receiving transaction data for approval, wherein the transaction data includes attribute data; deriving the context information for the transaction data from at least one of a financial institution associated with the transaction data, a vendor associated with the transaction data, a user associated with the transaction data, and/or an employer associated with the user; determining whether to approve the transaction data based on at least one of the attribute data and the derived context information; and in response to the transaction data being pre-approved, updating a record associated with the transaction data to indicate the approval.

Aspects of the above include one or more of: the context information comprising a location of the user; the location of the user being determined using a Global Positioning System (“GPS”) or other satellite-based location system on a device associated with the user; the context information comprising budget information from the employer; the context information comprising a time of year. the context information comprising a Merchant Category Code (MCC); the attribute data including state data, wherein the state data comprises one of: authorized, approved, declined, adjusted, or settled; the transaction data comprising multiple authorizations associated with a single settlement amount; and the transaction data comprising multiple settlements associated with a single authorization amount.

Embodiments include a system comprising a communications interface that enables communications with a communication device of a selected user; an arithmetic logic unit and control unit coupled to the communications interface, wherein the arithmetic logic unit performs one or more mathematical operations and compares selected variables and the control unit executes instructions; a register to hold a value from a comparison of selected variables performed by the arithmetic logic unit; a computer-readable storage memory comprising transaction data, authorization rules, and instructions that are executable by the control unit; an instruction decoder to provide read and write commands to the computer-readable storage memory; an address bus to provide a location address to the computer-readable storage memory for a read or write operation; a data bus, coupled with the arithmetic logic unit, control unit, register, computer-readable storage memory, instructions decoder and address bus, to provide or access data for a write or read operation to or from the computer-readable storage memory; wherein the arithmetic logic unit and/or control unit, in response to the control unit executing the instructions: receives a transaction for approval; updates transaction data associated with the transaction to indicate that the transaction has a first state; processes a set of authorization rules; determines whether to pre-approve the transaction based on the set of authorization rules; in response to the transaction not being pre-approved, submits the transaction for approval; in response to the transaction being pre-approved, abstains from submitting the transaction for approval; and thereafter updates transaction data to change a state of the transaction from the first state to a different second state.

Embodiments include a method comprising the steps of: receiving by a microprocessor and from a computing device, a transaction for approval; updating transaction data associated with the transaction to indicate that the transaction has a first state; processing, by the microprocessor, a set of authorization rules; determining, by the microprocessor, whether to pre-approve the transaction based on the set of authorization rules; in response to the transaction not being pre-approved, submitting, by the microprocessor, the transaction for approval; in response to the transaction being pre-approved, not submitting, by the microprocessor, the transaction for approval; and thereafter updating transaction data to change a state of the transaction from the first state to a different second state.

Aspects of the above include one or more of: the transaction being associated with a purchase of a product; the set of authorization rules comprising inheritance of approval from another purchase transaction; the set of authorization rules comprising a context based on time; the transaction being associated with a purchase of a product; the purchase transaction being submitted for approval comprising an approval user approving the purchase transaction; the control unit requesting additional information from a user; the arithmetic logic unit processing the additional information to determine whether a pending payment associated with the purchase transaction should be approved; the control unit processing a user's transaction data to determine upcoming events and notifying the user of the upcoming events; the control unit tracking an amount remaining on a per diem basis and making suggestions based on the amount remaining; the suggestions comprising restaurant suggestions; the control unit and/or arithmetic logic unit receiving a rating for a merchant and storing and aggregating the rating for each individual merchant.

Embodiments include a system for providing discrete and separate notifications for an application running on a communication device. The system comprises a communications interface that enables communications with a communication device of a selected user; an arithmetic logic unit and control unit coupled to the communications interface, wherein the arithmetic logic unit performs one or more mathematical operations and compares selected variables and the control unit executes instructions; a register to hold a value from a comparison of selected variables performed by the arithmetic logic unit; a computer-readable storage memory comprising instructions that are executable by the control unit, wherein the instructions comprise an application; an instruction decoder to provide read and write commands to the computer-readable storage memory; an address bus to provide a location address to the computer-readable storage memory for a read or write operation; a data bus, coupled with the arithmetic logic unit, control unit, register, computer-readable storage memory, instructions decoder and address bus, to provide or access data for a write or read operation to or from the computer-readable storage memory; wherein the arithmetic logic unit and/or control unit, in response to the control unit executing the instructions: maintain multiple counters associated with multiple notifications from multiple channels within the application and display an application launch icon associated with the application, wherein the application launch icon is able to simultaneously display multiple badges associated with the multiple notifications.

Embodiments include a method of providing discrete and separate notifications for an application running on a communication device, the method comprising the steps of: maintaining multiple counters associated with multiple notifications from multiple channels within the application and displaying an application launch associated with the application, wherein the application launch icon is able to simultaneously display multiple badges associated with the multiple notifications.

Aspects of the above include each different notification having a different color.

Embodiments include a system comprising: a communications interface that enables communications with a communication device of a selected user; an arithmetic logic unit and control unit coupled to the communications interface, wherein the arithmetic logic unit performs one or more mathematical operations and compares selected variables and the control unit executes instructions; a register to hold a value from a comparison of selected variables performed by the arithmetic logic unit; a computer-readable storage memory comprising instructions that are executable by the control unit; an instruction decoder to provide read and write commands to the computer-readable storage memory; an address bus to provide a location address to the computer-readable storage memory for a read or write operation; a data bus, coupled with the arithmetic logic unit, control unit, register, computer-readable storage memory, instructions decoder and address bus, to provide or access data for a write or read operation to or from the computer-readable storage memory; wherein the arithmetic logic unit and/or control unit, in response to the control unit executing the instructions: receives a balance inquiry associated with a transaction, wherein the balance inquiry is associated with a first entity in a plurality of entities, wherein plural parallel processing threads are currently processing different balance inquiries for the different entities, and wherein each of the processing threads corresponds to a different one of the plurality of entities; compares selected information in the received balance inquiry with plural sets of information associated with the plurality of entities to determine that the balance inquiry is associated with the first entity; processes the received balance inquiry in a first processing thread of the plurality of parallel processing threads associated with the first entity; and updates transaction data associated with the transaction to reflect an output of the first processing thread.

Embodiments include a method comprising the steps of: receiving, by a microprocessor, a balance inquiry associated with a transaction, wherein the balance inquiry is associated with a first entity in a plurality of entities, wherein plural parallel processing threads are currently processing different balance inquiries for the different entities, and wherein each of the processing threads corresponds to a different one of the plurality of entities; comparing, by the microprocessor, selected information in the received balance inquiry with plural sets of information associated with the plurality of entities to determine that the balance inquiry is associated with the first entity; processing, by the microprocessor, the received balance inquiry in a first processing thread of the plurality of parallel processing threads associated with the first entity; and updating, by the microprocessor, transaction data associated with the transaction to reflect an output of the first processing thread.

Aspects of the above include one or more of: the plurality of entities corresponding to a plurality of companies and the first entity corresponding to a first company; the balance inquiry being associated with a first employee of the first company in a plurality of employees of the first company; plural parallel processing threads are currently processing a different balance inquiry associated with the first company; each of the processing threads corresponding to a different one of the plurality of employees; the arithmetic logic unit, in response to executing the instructions, processes, by the plurality of employee processing threads, the received balance inquiry to determine that the received balance inquiry corresponds to the first employee; in each of the plural processing threads for the plurality of companies, a hash of a private account number associated with each of the plurality of companies is compared against the selected information in the received balance inquiry and wherein, in each of the plural processing threads for the plurality of employees, a hash of a communication address associated with each of the plurality of first company employees is compared against the selected information in the received balance inquiry; the arithmetic logic unit, in response to executing the instructions, compares a transaction category associated with a budget for the first employee against a transaction category associated with the received balance inquiry to determine whether to approve the received balance category for payment; compares a date range associated with the budget life with a timestamp of the transaction to determine whether the budget is active to authorize payment of the received balance inquiry; and compares an amount of the budget with an amount of the transaction to determine whether the budget has adequate funds to authorize payment of the received balance inquiry.

Embodiments include a system comprising: a communications interface that enables communications with a communication device of a selected user; an arithmetic logic unit and control unit coupled to the communications interface, wherein the arithmetic logic unit performs one or more mathematical operations and compares selected variables and the control unit executes instructions; a register to hold a value from a comparison of selected variables performed by the arithmetic logic unit; a computer-readable storage memory comprising instructions that are executable by the control unit; an instruction decoder to provide read and write commands to the computer-readable storage memory; an address bus to provide a location address to the computer-readable storage memory for a read or write operation; a data bus, coupled with the arithmetic logic unit, control unit, register, computer-readable storage memory, instructions decoder and address bus, to provide or access data for a write or read operation to or from the computer-readable storage memory; wherein the arithmetic logic unit and/or control unit, in response to the control unit executing the instructions: receiving transaction data relating to a selected transaction and a budget for the selected transaction, the selected transaction and budget being associated with an identified first user; applying a set of deterministic rules to the transaction data to provide a first outcome for the selected transaction; applying a set of heuristic rules to the transaction data to provide a second outcome for the selected transaction; processing, using learnings, the first and second outcomes to provide a third outcome of the transaction; receiving input from a human reviewer to convert the first, second, and third outcomes into a final outcome; and updating the learnings to comprise the final outcome to be applied to a future transaction.

Embodiments include a method comprising the steps of: receiving transaction data relating to a selected transaction and a budget for the selected transaction, the selected transaction and budget being associated with an identified first user; applying, by a rules engine, a set of deterministic rules to the transaction data to provide a first outcome for the selected transaction; applying, by the rules engine, a set of heuristic rules to the transaction data to provide a second outcome for the selected transaction; processing, by a machine learning module and using learnings, the first and second outcomes to provide a third outcome of the transaction; receiving input from a human reviewer to convert the first, second, and third outcomes into a final outcome; and updating the learnings to comprise the final outcome to be applied by the machine learning module to a future transaction.

Any one or more of the aspects/embodiments as substantially disclosed herein.

Any one or more of the aspects/embodiments as substantially disclosed herein optionally in combination with any one or more other aspects/embodiments as substantially disclosed herein.

One or more means adapted to perform any one or more of the above aspects/embodiments as substantially disclosed herein.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU), or logic circuits programmed with the instructions to perform the methods (FPGA). These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process, which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium, such as a storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method of providing discrete and separate notifications for an application running on a communication device, the method comprising:
maintaining multiple counters associated with multiple notifications from multiple channels within the application; and
displaying an application launch associated with the application, wherein the application launch icon is able to simultaneously display multiple badges associated with the multiple notifications.

2. The method of claim 1, wherein each different notification has a different color.
